(19) United States
(12) Patent Application Publication
(10) Pub. No.: US 2001/0033734 A1
(43) Pub. Date: Oct. 25, 2001

(54) Image information processing system

(75) Inventors: Takeo Hoda, Osaka-shi (JP); Dai Shintani, Osaka-shi (JP); Yoshihiro Tanaka, Osaka-shi (JP); Hiroshi Ishibe, Osaka-shi (JP); Hirokazu Naruto, Osaka-shi (JP); Hirokazu Yamada, Osaka-shi (JP); Nobuyuki Taniguchi, Osaka-shi (JP); Katsuyuki Nanba, Osaka-shi (JP)

Correspondence Address: SIDLEY AUSTIN BROWN & WOOD, 717 NORTH HARWOOD, SUITE 3400, DALLAS, TX, 75201, US

(73) Assignee: Minolta Co., Ltd.,

(21) Appl. No.: 09/768,667

(22) Filed: Jan. 24, 2001

Related U.S. Application Data
(62) Division of application No. 08/468,437, filed on Jun. 6, 1995.
Application No. 08/468,437 is a division of application No. 08/294,883, filed on Aug. 23, 1994.
Application No. 08/294,883 is a continuation of application No. 08/141,898, filed on Oct. 22, 1993, now abandoned.
Application No. 08/141,898 is a continuation of application No. 07/517,206, filed on May 1, 1990, now abandoned.

(30) Foreign Application Priority Data
May 2, 1989 (JP) 1-113334
May 2, 1989 (JP) 1-113335
May 17, 1989 (JP) 1-123189
May 26, 1989 (JP) 1-133240

(51) Int. Cl. H04N 5/76; H04N 5/781; H04N 5/225

(52) U.S. Cl. 386/46; 386/117; 386/125

(57) ABSTRACT

An image information processing system includes a first storage medium for recording image information, a selector for selecting one of the plurality of recordable portions, and a first recorder for recording image information on the selected recordable portion, a second storage medium having a plurality of recordable portions, a transfer for transferring the image information recorded on the first storage medium to the second storage medium, a designator for designating a recordable portion of the second storage medium for the image information to be transferred, and a second recorder for recording the image information on the designated recordable portion, whereby the image information can be desirably edited.

### BACKGROUND OF THE INVENTION AND RELATED ART STATEMENT

The present invention relates to an image information processing system which transfers or reproduces images photographed by an electronic still camera according to needs.

There have been proposed several systems. For example, Japanese Unexamined Patent Publication No. 59-70091 discloses a system in which an image signal obtained by a pick-up device is separated into three colors, compressed in a digital PCM manner, and stored in a memory. The image is reproduced on a TV.

Japanese Unexamined Patent Publication No. 63-284987 discloses a system in which an image signal obtained by a pick-up device is stored in a memory card mountable on the electronic still camera.

Japanese Unexamined Patent Publication No. 63-274289 discloses a system in which an image signal obtained by a pick-up device is converted to a component signal and then stored in a semiconductor storage module mountable on the electronic still camera. The image signal is processed into a signal for TV and reproduced on a TV.

Japanese Unexamined Patent Publication No. 54-140510 discloses a system in which images photographed by an electronic still camera is stored in an internal memory of the still camera. Thereafter, the image data is transferred from the internal memory to an external memory. The image is reproduced on a printer or facsimile machine.

Japanese Unexamined Patent Publication No. 61-189785 discloses a system in which an image photographed by an electronic still camera is stored in an internal memory of the still camera. The stored image is printed out.

Japanese Unexamined Patent Publication No. 62-21310 discloses a system in which images photographed by an electronic still camera is stored in an internal memory of the still camera. Thereafter, the image data is transferred from the internal memory to an external memory and reproduced.

Japanese Unexamined Patent Publication No. 64-47177 discloses a digital electronic still camera having a first memory and a second memory connectable with the first memory, the capacity of the second memory being greater than that of the first memory. Image signals are firstly stored in the first memory. When the first memory is saturated, the second memory is used.

There has been known a document showing a system in which image data is compressed in a DCT manner, stored in an IC card, and further stored in DAT.

However, there have been the following drawbacks in the above-mentioned prior art.

In the systems of Japanese Unexamined Patent Publication Nos. 59-70091 and 63-274289, images are reproduced only on TV. Also, the system of Japanese Unexamined Patent Publication No. 63-274289 uses no compression of image signal.

Japanese Unexamined Patent Publication No. 54-140510 does not disclose processing of image signals for reproduction on a printer or facsimile machine.

In the systems of Japanese Unexamined Patent Publication Nos. 63-284987 and 63-274289, the electronic still camera is not provided with an internal memory. Accordingly, if the memory card or semiconductor module is not mounted, photographed images are impossible to be stored or reproduced.

In the systems of Japanese Unexamined Patent Publication Nos. 61-189785 and 62-21310, photographed images are stored only in the internal memory. Accordingly, these systems provide insufficient capacity for actual needs.

Japanese Unexamined Patent Publication No. 64-47177 does not describe reproduction of image signals stored in the first and second memories.

The document showing the system in which image data is compressed in a DCT manner, stored in an IC card, and further stored in DAT does not disclose other than DCT compression.

Accordingly, it will be seen that the above-mentioned prior art has less flexibility and is applied for a limited use.

Also, Japanese Unexamined Patent Publication No. 64-30026 discloses a system in which image signals obtained by an electronic still camera are stored in an IC card. The image signals stored in the IC card are transferred to an optical disc.

However, in this system, the whole image signals stored on the IC card are dead copied to the optical disc. Accordingly, the image signals cannot be desirably separated and cannot be edited according to needs.

Furthermore, Japanese Unexamined Patent Publication No. 64-30026 discloses that in order to enhance the system's retrieval and storage capabilities, an index is provided on a surface of the optical disc.

Japanese Unexamined Patent Publication No. 64-35662 discloses a system in which desired retrieval conditions can be set for already recorded information and displayed in the form of a summary list. Further, this system facilitates retrieval of information by allowing a specified information to be displayed or printed as a sample image or deleted, if necessary.

However, in the system of Japanese Unexamined Patent Publication No. 64-30026, it is difficult to rewrite the retrieval information since it is directly written on the surface of the optical disc. Further, this system does not provide sufficient retrievability since a single optical disc can not record various images having multiple retrieval conditions.

Japanese Unexamined Patent Publication No. 64-35662 discloses the above-mentioned retrieval manner, but does not disclose any manner of recording retrieval information on a storage medium such as a floppy disc or a hard disc.

### SUMMARY OF THE INVENTION

It is an object of the present invention to provide an image information processing system which has overcome the above-mentioned drawbacks.

According to the present invention, an image information processing system comprises a storage medium having a plurality of recordable portions, selection means for selecting one of the plurality of recordable portions, and recording means for recording image information on the selected recordable portion.

Also, an image information processing system of the present invention comprises a first storage medium for recording image information, a second storage medium having a plurality of recordable portions, transfer means for transferring the image information recorded on the first storage medium to the second storage medium, designation means for designating a recordable portion of the second storage medium for the image information to be transferred, and recording means for recording the image information on the designated recordable portion.

According to the present invention, further, a system for recording a photographed image comprises a camera including a first reception unit for receiving a memory card, image signal generation means for generating an analog image signal, first signal processing means for converting the analog image signal to a digital image signal, and compressing the digital image signal, first recording means for recording the compressed image signal on the memory card, and an editing device including, a second reception unit for receiving a memory card and an optical disc, second signal processing means for expanding the compressed image signal recorded on the memory card, second recording means for recording the expanded image signal on an optical disc.

According to the present invention, further, an editing device comprises a reception unit for receiving a plurality of storage mediums, each storage medium being capable of recording and reading image information, selection means for selecting a pair of a storage medium having image information to be transferred and another storage medium for recording the image information among the plurality of storage mediums, transfer means for transferring the image information between the selected pair of storage mediums.

According to the present invention, further, a camera comprises a camera body, storage means including a first memory capable of storing image information corresponding to two photographic frames or more, and a second memory, recording means for recording image information on one of the first memory and the second memory, changer means for changing from the recording of image information on the first memory to the recording of image information on the second memory and vice versa.

According to the present invention, further, a camera comprises a camera body, storage means including a first memory capable of storing image information corresponding to two photographic frames or more, and a second memory, reproduction means for reproducing image information recorded on one of the first memory and the second memory, changer means for changing from the reproduction of image information recorded on the first memory to the reproduction of image information recorded on the second memory and vice versa.

According to the present invention, further, an editing device comprises a first reception unit for receiving a first storage medium holding image information, a second reception unit for receiving a second storage medium having a plurality of recordable portions, transfer means for transferring image information recorded on the first storage medium to the second storage medium, designation means for designating a recordable portion of the second storage medium for the image information to be transferred, and recording means for recording the image information on the designated recordable portion.

According to the present invention, further, an editing device for a camera capable of compressing an image signal and recording the compressed image signal on a memory card comprises a first reception unit for receiving a memory card, a second reception unit for receiving an optical disc, signal processing means for expanding the compressed image signal recorded on the memory card, and recording means for recording the expanded image signal on the optical disc.

The present invention makes it possible to record image information on a desirably selected recordable portion. Also, the present invention makes it possible to obtain image information edited in accordance with a desired format. Further, the present invention makes it possible to reproduce image information according to needs, and record image information on an increased number of kinds of storage medium. Moreover, the present invention provides a camera of a reduced size and an increased number of recordable portions. The present invention provides an image information processing system having an extended adaptability and practicability, and an enhanced retrievability.

These and other objects, features and advantages of the present invention will become more apparent upon a reading of the following detailed description and drawings.

### BRIEF DESCRIPTION OF THE DRAWINGS

FIG. 1 is a configuration diagram of an image information processing system of the present invention;

FIG. 2A is a perspective view of a camera used in the system;

FIG. 2B is another perspective view of the camera, a movable member of the camera being withdrawn;

FIG. 3 is a block diagram of the camera;

FIG. 4 is a block diagram showing an internal circuit structure of a unit including a CCD and an IC card;

FIG. 5 is a block diagram of a printer section of the system;

FIG. 6 is a block diagram of a circuit for reproduction of recorded images on a TV screen;

FIG. 7 is a flowchart showing an image processing sequence;

FIG. 8 is a memory map illustrating where image data picked up by the CCD is stored in an internal memory;

FIG. 9A is a diagram illustrating the printer section before put into work;

FIG. 9B is a diagram illustrating the printer section put into work;

FIG. 10 is a diagram showing a heat transfer ink film;

FIG. 11 is a block diagram showing the construction of the printer section;

FIG. 12 is a block diagram of a circuit for providing a monitoring image on a display window;

FIGS. 13A-17 are flowcharts showing operations of the camera;

FIG. 18 is a block diagram showing reproduction of NTSC signals read out of an IC card on a TV;

FIG. 19 is a block diagram showing transfer of NTSC signals from an IC card to a CD ROM;

FIG. 20 is a block diagram showing output of NTSC signals from an IC card to a videophone;

FIG. 21 is a block diagram showing output of NTSC signals from an IC card to a facsimile machine;

FIG. 22 is a block diagram showing transfer of RGB signals from an IC card to a TV to reproduce an image;

FIG. 23 is a block diagram showing transfer of RGB signals from an IC card to a CD-ROM;

FIG. 24 is a block diagram showing transfer of RGB signals from an IC card to a videophone;

FIG. 25 is a block diagram showing output of RGB signals from an IC card to a facsimile machine;

FIG. 26 is a block diagram showing transfer of color difference signals from an IC card to a TV to reproduce an image;

FIG. 27 is a block diagram showing transfer of color difference signals from an IC card to a CD-ROM;

FIG. 28 is a block diagram showing transfer of color difference signals from an IC card to a videophone;

FIG. 29 is a block diagram showing output of color difference signals from an IC card to a facsimile machine;

FIG. 30 is a block diagram showing transfer of NTSC signals compressed by ADCT modulation from an IC card to a CD-ROM;

FIG. 31 is a block diagram showing transfer of NTSC signals compressed by ADCT modulation from an IC card to a facsimile machine;

FIG. 32 is a block diagram showing combination of a videophone and a facsimile machine;

FIG. 33 is a block diagram of a CD-ROM driver;

FIG. 34 shows an operating panel provided on the front of the CD-ROM driver;

FIG. 35 shows an operating panel of a remote controller;

FIG. 37 is a flowchart showing an operating sequence followed by the CD ROM driver for executing image editing operations such as retrieval or reproduction of images;

FIGS. 38-47 are flowcharts of individual sub-routines shown in the flowchart of FIG. 37;

FIGS. 48a-48c2 show menu screens presented on the TV monitor when “Playback” is selected in the menu mode;

FIGS. 49a-49d show menu screens presented on the TV monitor when “Copy” is selected in the menu mode;

FIGS. 50a-50d2 show menu screens presented on the TV monitor when “Erase” is selected in the menu mode;

FIGS. 51a-51b show menu screens presented on the TV monitor when “Other Functions” is selected in the menu mode; and

FIG. 52 is a format presented on the TV monitor when a multi-window mode is selected.

### DETAILED DESCRIPTION OF PREFERRED EMBODIMENTS OF THE INVENTION

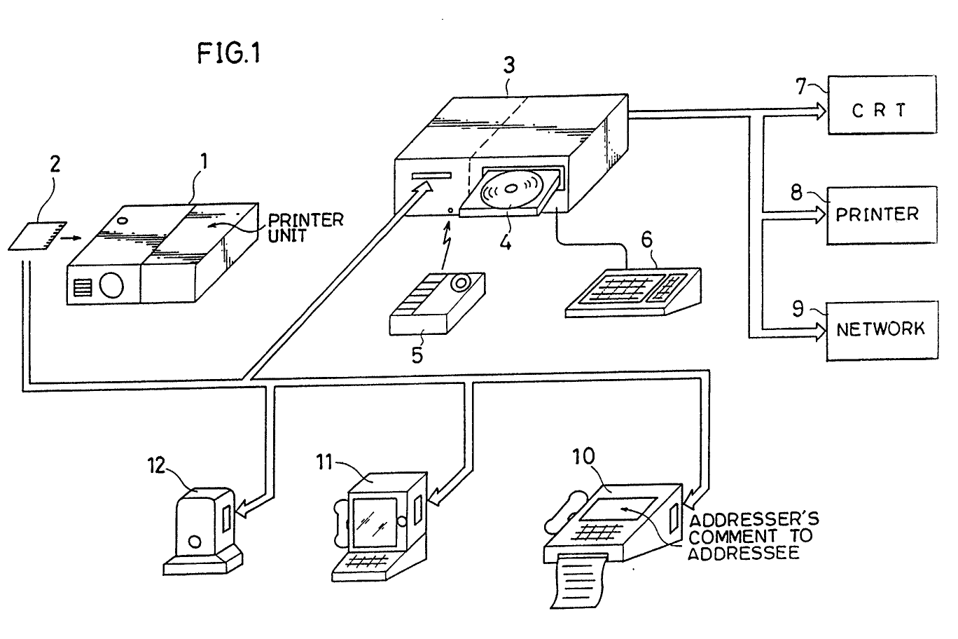

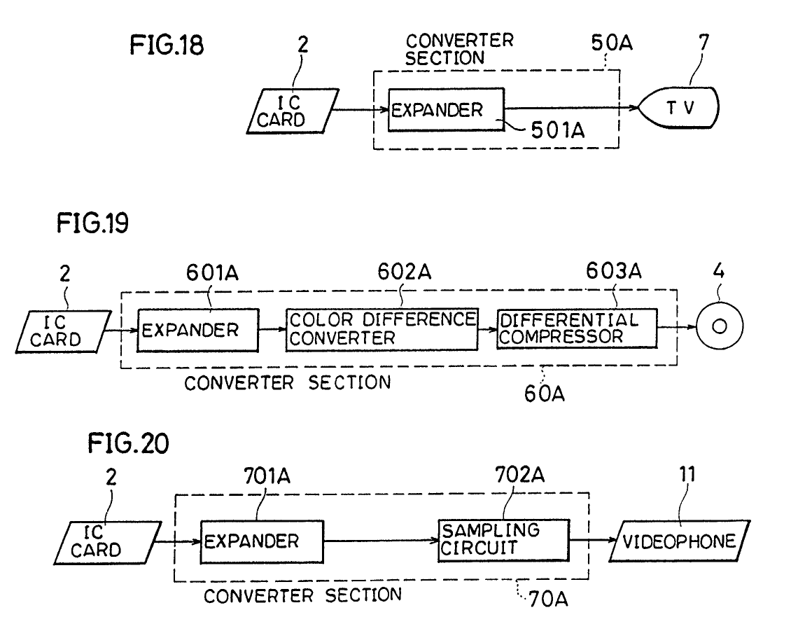

The following description of an image information processing system of the present invention has two parts, one part describing a main camera unit referring to FIGS. 1 through 17 and the other part describing an image reproduction device referring to FIGS. 18 through 52. The description of the main camera unit refers to the construction, block diagrams (operation) and flow charts in this order while the description of the image reproduction device refers to block diagrams showing interconnections with individual peripherals, configuration of a CD-ROM driver and menu mode screens in this order.

FIG. 1 shows an overall configuration of the image information processing system.

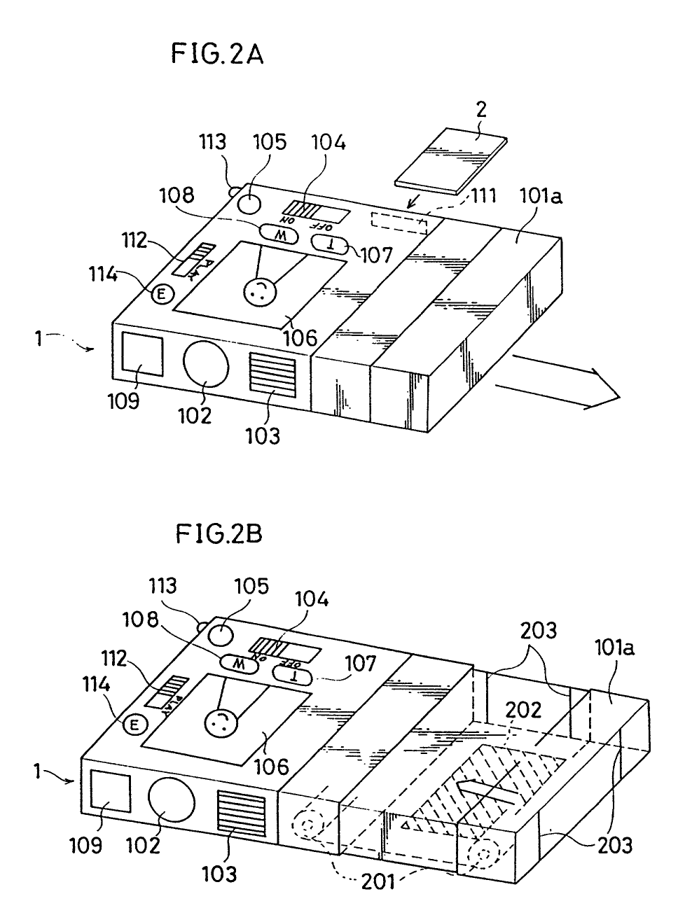

Indicated at 1 in FIG. 1 is a camera provided with a printer section and a monitor section. A detailed construction of the camera is illustrated in FIGS. 2A and 2B. Indicated at 2 in FIG. 1 is a first storage medium (hereinafter called the IC card) including a SRAM, for example, associated with an internal memory backup battery. The IC card is removable from the camera 1 and, when installed, stores images photographed by the camera 1 as explained later. This IC card is configured so that it can be connected to individual peripheral devices to be described later. Indicated at 3 is a CD-ROM driver which transfers already recorded images from the IC card 2 to a CD-ROM 4 or vice versa in order to store the images in the destination storage medium. The above-mentioned CD-ROM 4 is a direct read after write optical disc with a 540 Mbyte storage capacity provided with a rewritable memory area. It not only enables write-once, read-many operations but also erasure of existing data. Erasure of data is achieved by writing an erasure code which makes an already recorded image unreadable so that it looks as if the image has actually been erased. Accordingly, new data is written in a different area of the CD-ROM. In the explanation to follow in this specification, this operation is simply referred to as erasure.

The Compact Disc Interactive Media (hereinafter called the CD-I) also based on the same CD-ROM 4 is known as a system which allows flexible, mutual access to various kinds of digital information including not only computer data but also audio signal and still image data. The following table shows main specifications of the CD-I system.

| Item | Specifications |
|---|---|
| Number of | Standard mode: 360 × 240 |
| picture | High definition mode: 720 × 240 |
| elements | |
| Image data | Natural image: DYUV companding method |
| coding | Graphics: Command, Bit map image |
| generation | Simple animation: Run length companding |
| method | |
| Natural image | Standard mode: 7200 images/disc (max.) |
| storage | High definition mode: 1800 images/disc |
| capacity | (max.) |
| Special | Fading, Wiping, Scrolling, etc. |
| effects | |
| Audio signal | 16-bit PCM, 44.1 kHz (Audio CD) |
| coding | 8-bit ADPCM, 37.8 kHz (Same as LP record |
| | 4-bit ADPCM, 37.8 kHz (Same as FM radio) |
| | 4-bit ADPCM, 18.9 kHz (Same as AM radio) |
| MPU/OS | 68000 family MPU, OS-9 system software |

In the table:

MPU/OS represents Microprocessing Unit/Operating System;

DYUV represents Delta YUV;

PCM represents Pulse Code Modulation; and

ADPCM represents Adaptive Differential PCM.

Indicated at 5 in FIG. 1 is a remote controller which is used to remotely control the CD-ROM driver 3 by means of ultrasonic waves or light. Indicated at 6 is a keyboard used as a retrieval information input device for specifying which image stored in the CD-ROM 4 is to be reproduced. The CD-ROM driver 3 is designed to provide connectivity with a CRT 7 and a printer 8 for reproduction of recorded images as well as a telephone line or videophone line 9 for image data transfer. Image data is processed in the CD-ROM driver 3 before it can be outputted to such peripheral devices.

On the other hand, the IC card 2 is designed so that it can be plugged into a facsimile machine 10, a videophone 11 and a handy copier 12 (portable copy machine). A photographed image is transmitted via the phone line in case the IC card 2 is mounted to the facsimile machine 10 or videophone 11. It is copied in case the IC card 2 is mounted to the handy copier 12. Each individual part of the system is explained in further detail in the following.

First, the camera 1 is explained referring to FIGS. 2A and 2B.

FIG. 2A is a perspective view of the camera 1. In FIG. 2A, Indicated at 102 is an object lens, indicated at 103 is an electronic flash. Indicated at 104 is an ON/OFF switch which turns on the camera 1 at an ON position and turns off the camera 1 at an OFF position. Indicated at 105 is a dual function start button. It works as a photographing start button when shooting a subject, whereas it works as a printout start button when printing an image. Indicated at 106 is a display window provided at an appropriate location on a top surface of the camera 1. It may be constructed of an LCD panel, for example. When shooting a subject with the camera 1, an indication is given on the display window 106 showing that the camera in the photographing mode together with a readout of the frame number. When executing printout operation, the display window 106 indicates that the camera is in the print mode, while presenting the image reproduced from the IC card 2 where the photographed image is recorded or from an internal memory of the camera 1 as described later in this specification. Further, the display window 106 shows “Print in Process” and “Print Complete” status indications in addition to the frame number of the printed image while the printout operation is proceeding.

Indicated at 107 and 108 are push button switches which set the object lens 102 to the telephoto and wide angle lens positions respectively when photographing. Consequently, the object lens is switched between two different magnification settings. Switches 107 and 108 are also used to sequentially advance the recorded images in the normal or reverse order during the reproduction process.

A movable member 101a provided at the side of the camera body houses a built in printer, which becomes ready to print when drawn out in the direction of an arrow. Indicated at 109 is a viewfinder lens. Indicated at 112 is a TV output on/off switch. Indicated at 113 is a TV output terminal. Indicated at 114 is an erasure switch which is used to erase an already recorded image. Indicated at 111 is a slot for the IC card 2. A photographed image is recorded on the IC card 2 inserted in this slot.

FIG. 2B shows another state of the camera in which when the printer is set ready to print by withdrawing out a movable member 110a from its original position shown in FIG. 2A.

Common part numbers are used in FIGS. 2A and 2B to identify the same parts.

A thermal head (indicated at 420 in FIGS. 9A and 9B), a heat transfer ink film 201 and a printing frame 202 (hatched part) come into view when the movable block 101a is drawn out. If the printout start button 105 is pressed in this condition, the thermal head 420 starts to scan while moving in the arrow direction. Thus, the desired image is printed on paper set just beneath the printing frame 202. The thermal transfer ink film 201 has a sufficient width to cover the printing frame 202. To indicate the printing position to an operator, paper positioning lines 203 are marked on the rear and right sides of the movable member 101a.

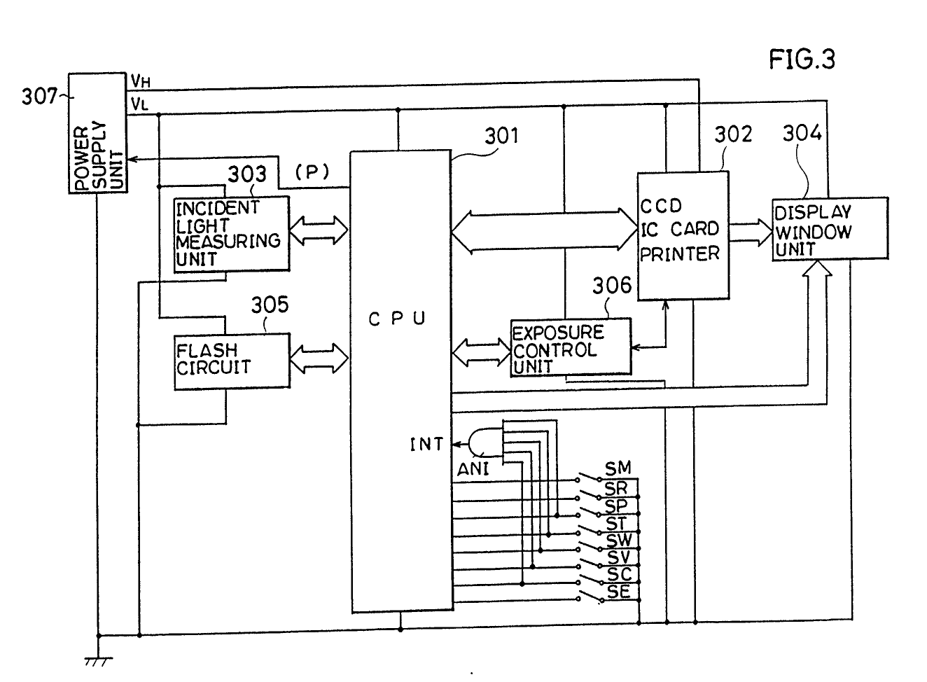

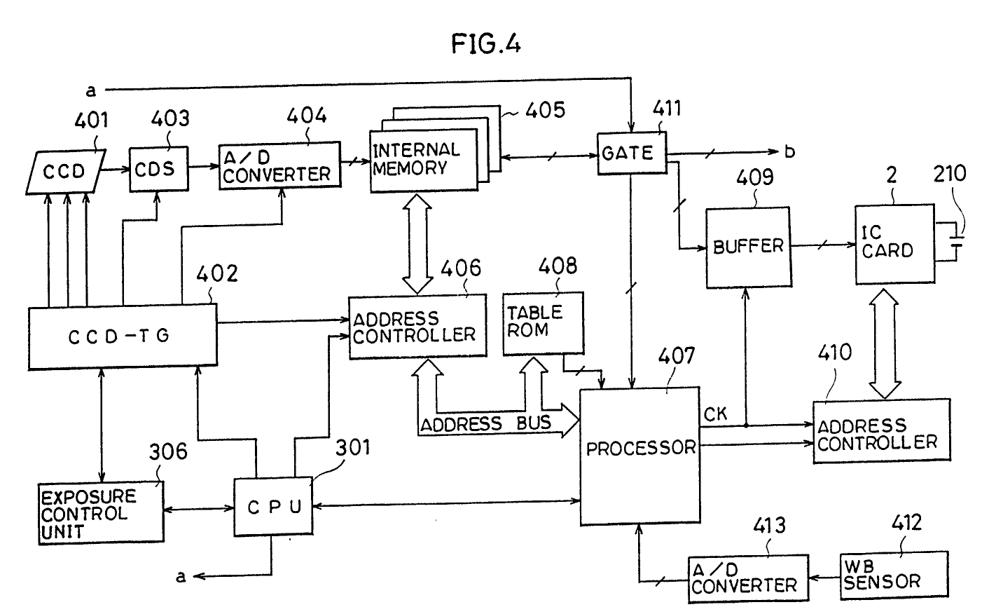

FIG. 3 is a block diagram of the camera 1. Indicated at 301 in FIG. 3 is a system controller (hereinafter called the CPU) which controls the overall operation of the camera 1 including the built in printer. Indicated at 302 is a unit comprising a solid state imaging device (hereinafter called the CCD) into which a photographed image is read and associated circuits which drive the CCD and perform processing of input image, recording of image data on the IC card 2 and printing operation. A detailed description of this unit 302 is given in a later section. Indicated at 303 is an incident light measuring unit which measures luminance of the subject and outputs the light measurement data to CPU 301. Indicated at 304 is a display window unit made up of the display window 106 described in FIGS. 2A and 2B and its drive circuit. This unit 304 displays the data coming from CPU 301 and reproduces the image recorded in unit 302 on the display window 106. Indicated at 305 is a flash circuit including the electronic flash 103 shown in FIGS. 2A and 2B, a capacitor to store electric charges and associated components. Upon receiving control signals from CPU 301, the flash circuit 305 charges electric energy into the capacitor, causes the electronic flash 103 to glow and outputs a signal to CPU 301 to notify that the capacitor has been fully charged. Indicated at 306 is an exposure control unit which controls exposure of the camera based on exposure time TV, aperture setting value AV and other calculation results received from CPU 301 as well as the CCD drive timing signal derived from CCD-TG (FIG. 4) to be described in a later section. Indicated at 307 is a power supply unit which produces a high voltage VH of 20 V, for example, to drive the CCD and a low voltage VL of 5 V, for example, to drive other individual elements. The power supply unit 307 is designed to supply the high voltage VH to the CCD in accordance with a signal (P) sent from CPU 301. Next, switches SM through SE are explained. SM is a main switch which starts up the camera including the printer. This switch corresponds to switch 104 shown in FIG. 2A. SR is a start switch which functions as a photographing start button when shooting a subject and a printout start button when printing an image. This switch corresponds to start button 105 shown in FIG. 2A. SP is a switch which turns on when the movable unit 110a is drawn out of the camera body upon detecting that the printer has become ready to print.

ST is a push-button switch used to set the object lens 102 to the telephoto lens position when photographing. In other than photographing operations such as image reproduction, switch ST works as a button to advance images in the normal order so that images recorded in the IC card 2 or internal memory of the camera 1 are reproduced sequentially. This switch corresponds to push button switch 107 shown in FIG. 2A. When ST is used as a sequential frame advance button, a succeeding frame of recorded image is reproduced each time it is turned on. SW is a push button switch used to set the object lens 102 to the wide angle lens position in the photographing process. In other than the photographing process such as image reproduction, switch SW works as a button to advance images in the reverse order so that images stored in the IC card 2 or internal memory of the camera 1 are reproduced sequentially. This switch corresponds to push button switch 108 shown in FIG. 2A. When SW is used as a sequential frame reversing button, a preceding frame of recorded image is reproduced each time it is turned on.

SV is a switch used when outputting an image recorded in the IC card 2 or internal memory of the camera 1 to a TV set (not illustrated) connected to the camera. This switch corresponds to switch 112 shown in FIG. 2A. An operator can monitor not only the normal size of image on the display window 106 but also an enlarged view of the photographed image on an associated TV screen by turning on switch SV. SC is a switch which detects whether the IC card 2 is mounted in the slot 111 of the camera. It turns on when the IC card 2 is in the slot. SE, corresponding to switch 114 in FIG. 2A, is an erasure switch which is used to erase an already stored image. If switch SE is turned on when a stored image is being printed or reproduced on a TV screen, the currently monitored image is erased from the IC card 2 or internal memory of the camera 1. Since the outputs of switches SP, ST, SW, SV and SC are connected to the inputs of an AND circuit AN1, an interrupt (INT) will occur if one of these switches turns on.

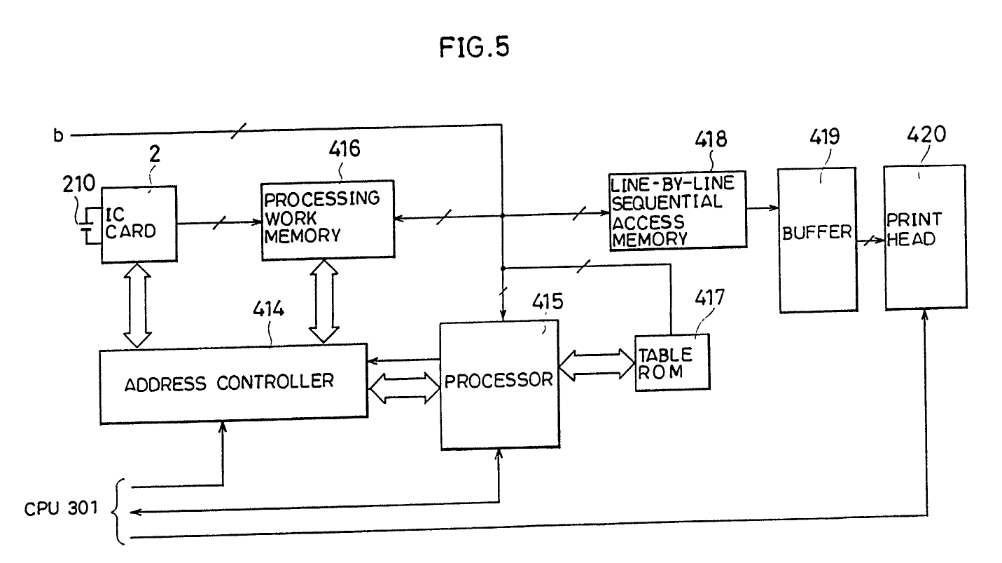

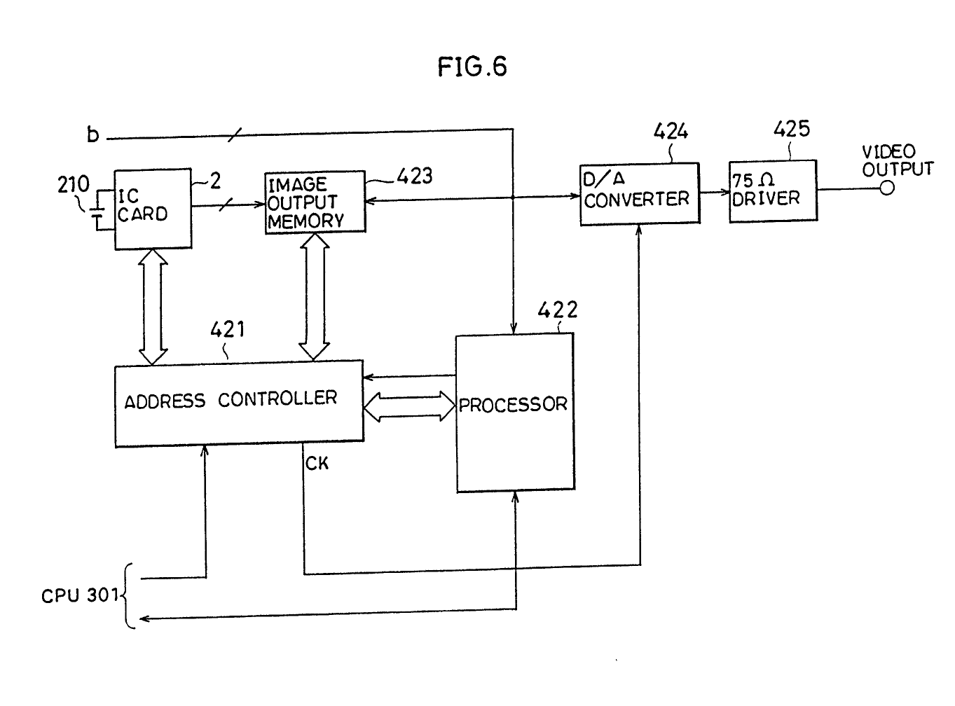

Next, FIG. 4 is a block diagram illustrating an internal circuit structure of the unit 302 shown in FIG. 3 including the CCD and IC card 2. FIG. 5 is a block diagram of the printer section. FIG. 6 is a block diagram of the circuit which reproduces a stored image on a TV screen.

As already explained, CCD 401 shown in FIG. 4 is a solid state imaging device provided with electronic shutter function and RGB stripe filters. CCD-TG 402 delivers control signals and clock signals to individual circuits of the unit. More specifically, CCD-TG 402 generates a shutter control signal for CCD 401, a clock signal for driving an image signal readout circuit, a clock signal for CDS 403, a clock signal for an A/D converter 404 and a clock signal for an address controller 406. CDS 403 samples the output image signal of CCD 401 to perform double correlation. The A/D converter 404 converts the output image signal of CCD 401 from analog to digital data. Although an 8-bit A/D converter 404 is employed in this preferred embodiment of the invention, a desired number of bits can be selected depending on the required image quality. Internal memory 405 is an SRAM, for example, featuring a short access time. It reads serial data from CCD 401 and stores image data. The internal memory 405 is provided with a working memory area to perform image data processing in addition to an image memory area having a capacity to save at least one frame of photographed image. The internal memory 405 also stores image data obtained after a data compression process.

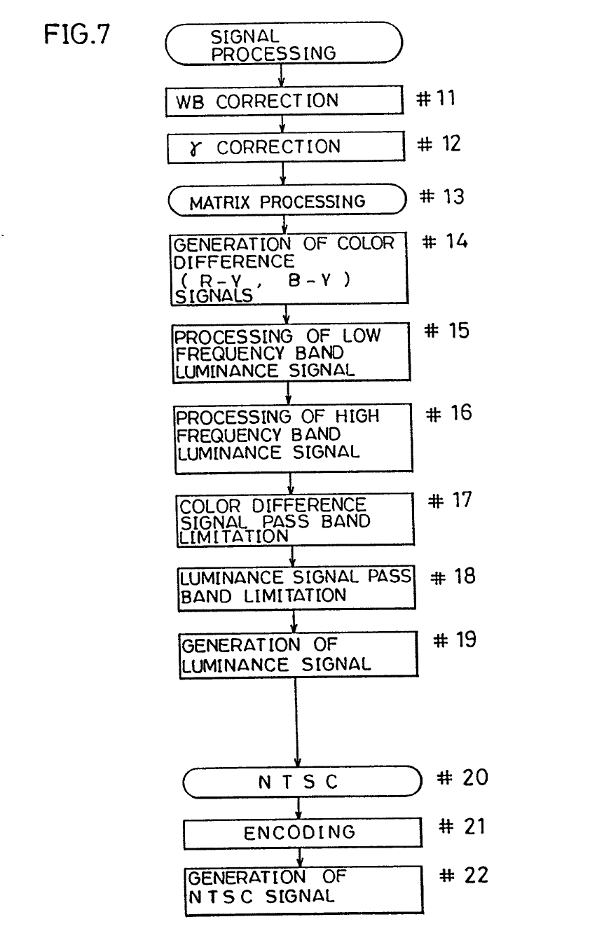

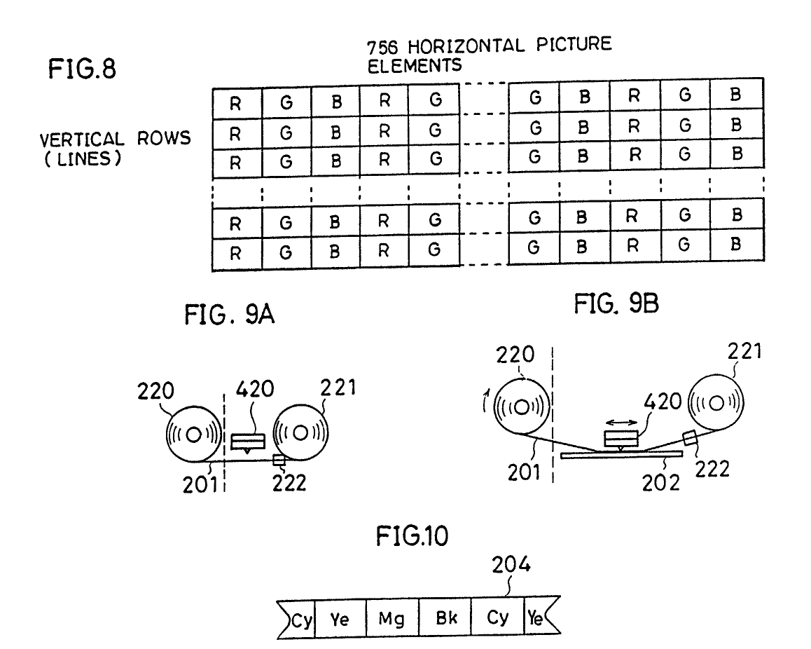

The address controller 406 is designed to function as follows. When reading data from CCD 401, it outputs a serial write address signal for the internal memory 405 upon receiving a clock signal from CCD-TG 405, and then outputs an address signal to the internal memory 405 after decoding an I/O output and address signal output from a processor 407 for image processing. Further, the address controller 406 reads a serial clock signal at a low speed to write the processed data in an external storage medium like the IC card 2. Table ROM 408 is a memory device in which the factor to be used when applying white balance (hereinafter called WB) correction and the γ correction factor to be used when applying color conversion for the printer and TV are preprogrammed. These two kinds of correction are discussed later in this Specification. The processor 407 applies various kinds of digital signal processing as shown in FIG. 7 to the incoming image data. The image data stored in the internal memory 405 according to the format illustrated in FIG. 8 is rewritten in the same addresses after the R, G and B components of the image data have gone through such processes as WB correction, γ correction and data compression process.

WB correction refers to a process in which the color temperature information received from the WB sensor 412 is converted by a conversion factor preprogrammed in the table ROM 408, whereas γ correction refers to a process in which the color-converted data is further converted by a conversion factor preprogrammed in the table ROM 408. The data compression process goes as follows, for instance. Raw data is first compressed to ⅔ after it has been separated into the luminance, or Y, signal and the color difference, or C (U, V), signal. Next, the resultant signals are compressed to 1/2 after calculating differences of the Y, U and V values from their preceding values. After all, the whole data compression process is considered as a DYUV compression system of the CD-I shown in Table 1 to compress the image data to ⅓.

A buffer 409 is provided between the internal memory 405 and IC card 2 to temporarily store the image data outputted from the internal memory 405. Address controller 410 generates read and write address signals to cause the contents of the buffer 409 to be outputted and written on the IC card 2.

Controlled by CPU 301, gate 411 switches connections between the internal memory 405, or IC card 2, and the processor 407, or connects the internal memory 405 to the IC card 2. Indicated at 413 is an A/D converter which converts the analog signal derived from the WB sensor 412 into a digital signal. Indicated at 210 is a built in battery of the IC card 2.

Now, functions of individual circuits are explained below in further detail based on the above block diagram description. When the start switch SR is turned on in the photographing mode, CPU 301 outputs a start signal to CCD-TG 402 while causing the light measuring unit 303 to perform incident light measurement. The exposure control unit 306 controls exposure of the camera according to the aperture setting value AV obtained from the result of light measurement. Then, it introduces light upon CCD 401 by outputting a shutter control signal to CCD-TG 402 depending on the exposure time data TV.

Upon completion of the above exposure process, CPU 301 switches the address controller 406 causing it to output a serial signal. CPU 301 also outputs a read enable signal to CCD-TG 402. Consequently, the image data read into CCD 401 is transferred to the internal memory 405. When data transfer has been finished, CPU 301 switches the address controller 406 to the processor side 407 to perform communications. CPU 301 then outputs command signals to apply signal processing such as WB correction, γ correction as well as data compression to the image data as detailed later in FIG. 7. After these signal processing steps, the image data is stored again in the internal memory 405.

In case the IC card 2 is set ready to store the image data, CPU 301 connects the internal memory 405 to the IC card 2 by switching the gate 411. Also, CPU 301 outputs an address signal to both address controllers 406 and 410. As a result, the image data in the internal memory 405 is transferred into the IC card 2 via the buffer 409.

Now, the block diagram of the printer section is described below referring to FIG. 5.

Address controller 414 transfers the compressed image data obtained through individual steps of signal processing from the IC card 2 to a specified area of a processing work memory 416 according to a command received from a processor 415. What is meant by the specified area is that the data is sequentially stored in one line after another of the memory, for instance. On the other hand, the address controller 414 decodes an address signal coming from the processor 415 and delivers the resultant address signal to the work memory 416 in each step of signal processing described later. The work memory 416 is an SRAM, for example, featuring a short access time. It is used to read the compressed data out of the IC card 2, to temporarily save the data and to store the results of signal processing. Table ROM 417 stores a γ correction factor for converting TV image data into print image data, and predefined bit map data to be used for area quantization, which is explained later, to apply density correction to printout picture elements. The processor 415 demodulates or expands the compressed data recorded on the IC card 2 and converts it into a format to suit the printer. It also performs the afore mentioned γ correction and area quantization by using the data read from the table ROM 417. More specifically, the compressed data is expanded to generate the luminance signal (Y) and the color difference signal (C) to be described later. From these signals the processor 415 produces complementary color signals that will match the respective ink colors of the printer. Then it performs γ correction suitable for the type of the printer in use based on the complementary color signals. Further, each color of each picture element is area quantized by use of the bit map data stored in the table ROM 417. The resultant data is written in a line sequential access memory 418 to generate print data with a 4-dot line width. Each time the above signal processing is completed for one line of print data, the processor 415 transmits a process end signal to CPU 301. The compressed data expansion process as used in the afore-mentioned CD-I system reproduces the original data by first calculating true color differences based on the data stored on the IC card 2 and then adding the color difference data to the immediately preceding values. When the compressed data expansion process is adapted to the ADCT system, which is described later, the original data is reproduced from the data recorded on the IC card 2 by a reversal of the conversion carried out in the compression process. γ correction refers to a process in which image data produced for presentation on a TV screen is converted into a different form of image data suitable for the printer. Also, area quantization refers to a process in which color density of each picture element is converted into the number of dots to be printed within a 16-dot area composed of 4 dots by 4 dots. The resultant dot number data is sequentially transferred to the line sequential access memory 418. In this process each 4×4 dot matrix segment is treated as a unit (or a picture element).

The line sequential access memory 418 stores one line of 4×4 dot data of individual picture elements and outputs one line of data (number of horizontal picture elements×4) at a time to a buffer 419 of a print head 420. When heated by the output of the buffer 419, the print head 420 transfers ink on the paper.

Now, functions of individual circuits are described below based on the above block diagram description. Print operation is started when CPU 301 detects a print start command in the print mode. When printing an image stored on the IC card 2, the address controller 414 causes the compressed data of the print image to be transferred from the IC card 2 to a specified area of the work memory 416. On the other hand, when an image stored in the internal memory 405 is printed directly, a frame of print image in the internal memory 405 is selected by the address controller 406 and transferred in the work memory 416 via the gate 411 and processor 416. Next, CPU 301 sends a command to the processor 415 requesting it to carry out signal processing for printing.

When the command has been received from CPU 301, the processor 415 reads the image data out of the work memory 416. The processor 415 then applies the afore-mentioned signal processing to the respective colors of ink in the order of Cy (cyan), Ye (yellow), Mg (magenta) and Bk (black). Upon detecting the end of processing of one line of data, CPU 301 execute a printout of that line by controlling the line sequential access memory 418 and print head 420. Upon completing printout of each individual line, the print head 420 advances one line in the direction of arrow shown in FIG. 2B to prepare itself to print a succeeding line. Printout of one frame of a single color image is accomplished in this way. After printout of the Cy (cyan) image has been completed, the Ye (yellow), Mg (magenta) and Bk (black) images are printed in this order by repeating the similar printing process. Printout of one complete frame is finished in this manner.

As an alternative to the above process, the print head 420 may be advanced one line forward after printing each line with all four colors. In this alternative printing method one frame of image is completed by a single vertical scanning.

FIG. 6 is a block diagram of a circuit which reproduces an image on a TV screen. An address controller 421 transfers the compressed image data from the IC card 2 to a specified area of an image output memory 423 according to a command received from a processor 422. What is meant by the specified area is that the data is sequentially stored in one line after another of the memory, for instance. On one hand, the address controller 421 decodes an address signal coming from the processor 422 and outputs the resultant address signal to the image output memory 423 when executing signal processing. On the other hand, the address controller 421 generates a serial read address signal and a clock signal for a D/A converter 424 while a composite video signal is being outputted from the image output memory 423. The image output memory 423 is an SRAM, for example, which features a short access time. It is used to read the compressed image data out of the IC card 2, to temporarily store the processed data occurring in the course of signal processing, and to save the resultant NTSC video signal. The processor 422 performs expansion of the compressed image data. It generates an NTSC composite signal by encoding the luminance signal (Y) and the color difference signal (C) through the expansion process, which is accomplished in a similar way to the afore-mentioned process. In the above encoding process the color difference signal (C) is modulated by a subcarrier and added to the luminance signal (Y). D/A converter 424 decodes the above-mentioned NTSC composite signal to obtain an analog TV signal. 75 Ωdriver 425 is an impedance matching circuit by which the video output is matched with the TV input.

The following circuit description delineates the operations carried out when outputting the video signal to the TV, referring to the above block diagrams.

When the TV reproduction mode is selected, CPU 301 detects a change of mode and starts reproduction of image on the TV screen. When reproducing an image stored on the IC card 2 via the TV output terminal 113, the compressed image data to be outputted to the TV is transferred to a specified area of the image output memory 423 by the address controller 421. On the other hand, when reproducing an image stored in the internal memory 405 on the TV screen, a frame of image (or page) to be reproduced is selected from the internal memory 405 by the address controllers 406 and 421, and read into the image output memory 423 via the gate 411 and processor 422. Subsequently, CPU 301 enables the processor 422 and address controller 421 to communicate each other and sends a command to the processor 422 requesting it to perform necessary signal processing for reproduction of image on the TV screen.

Upon receiving the command from CPU 301, the processor 422 reads the image data one line after another out of the image output memory 423. The processor 422 then applies the signal processing described later to the image data and writes the resultant digital NTSC signal in the image output memory 423 again. At this time, horizontal and vertical synchronizing signals are added to the image data. In case the original image consists of a field picture of half the normal horizontal line density, a pseudo frame image processing is applied to the image data when it is written in the image output memory 423, so that it looks as if one complete frame of image is recorded in the image output memory 423. The processor 422 outputs a process end signal at the end of processing of each individual frame image. After detecting the process end signal, CPU 301 switches the address controller 421 to the NTSC output mode. Thereupon, the image output memory 423 is set to output an NTSC composite signal and the D/A converter 424 is activated to output an analog TV signal.

Photographing, printing and output to the TV are executed in the respective modes described above.

FIG. 7 is a flowchart showing how the image signal derived from CCD 401 is A/D converted and how the resultant data is processed after it is read into the internal memory 405.

First, WB correction is applied to the R and B signals in step #11 to bring them to the same level with the G signal. In this process individual color signals are adjusted to the same level by using a color temperature factor determined by color temperature information derived from the afore-mentioned color measuring circuits 412 and 413 when photographing a reference white image obtained by projecting light of a set color temperature. This WB correction process is executed sequentially in a horizontal direction in units of three picture elements (R, G, and B) 256 (768/3) times or one line at a time.

Next, in step #12, γ correction is made to the G signal, and the R and B signals to which WB correction has already been applied. This γ correction is also executed sequentially in a horizontal direction in units of three picture elements (R, G, and B) one line at a time.

After the above-mentioned WB and γ corrections, matrix processing is applied to the signals in step #13 by using the functions shown below, for example, and the low frequency band luminance signal (Y) and color difference signals (R-Y and B-Y) are generated (#14):

$$Y = 0.30 R + 0.59 G + 0.11 B$$

$$R — Y = 0.70 R - 0.59 G - 0.11 B$$

$$B — Y = 0.89 B - 0.59 G - 0.30 R$$

Subsequently, the low frequency band luminance signal (Y) is processed in step #15. Then, in step #16, the R, G and B signals are individually multiplied by appropriate coefficients to reduce aliasing errors, and the levels of R, G and B that make up the dot sequential signal in the high frequency band are adjusted. As in the afore-mentioned signal processing, the low frequency band (#15) and high frequency band (#16) luminance signals are also processed sequentially in a horizontal direction in units of three picture elements (R, G, and B) one line at a time.

When the above processes have been completed, pass bands of the color difference signal and luminance signal are limited as necessary in steps #17 and #18 in a sequential (or horizontal) direction one line at a time. Further, the low frequency band and high frequency band luminance signals obtained in steps #15 and #16 are added in the frequency domain to generate a combined luminance signal (#19). This process of luminance signal generation is executed in a sequential (or horizontal) direction 256 times or one line at a time.

Before the image can be reproduced on a TV screen on completion of the foregoing processes, a burst signal, and horizontal and vertical synchronizing signals are added to the image signal to convert it to a standard television signals like the NTSC signal in steps #20 through #22.

FIGS. 9A and 9B are diagrams illustrating the operation of a thermal head. FIG. 10 is a diagram of a thermal transfer ink film 201.

Referring to FIGS. 9A and 9B, indicated at 201 is the thermal transfer film, indicated at 220 is a take-up reel of the thermal transfer ink film 201, indicated at 221 is a supply reel of the thermal transfer ink film 201, and indicated at 420 is the thermal head. As an example, cyan, yellow, magenta and black ink areas are arranged in order on the surface of the above-mentioned thermal transfer ink film 201 at regular intervals as shown in FIG. 10. The recurring interval of different ink areas is made equal to or longer than the length of the print area. Indicated at 222 is a color detecting sensor which discriminates the ink color just under the thermal head 420. In virtue of this color discrimination system, individual color images are printed with the respective color signals outputted from the line sequential access memory 418 to the thermal head 420.

FIG. 9A shows the status of the print mechanism before it starts printing, that is, when an image is being photographed, for example. The take-up reel 220 and take-up drive mechanism, which is not shown in the figure, are incorporated in the camera body but other than in the movable member 110a shown in FIG. 2. On the other hand, the supply reel 221, thermal head 420, color detecting sensor 222 and the associated drive mechanism are built in the movable member 110a shown in FIG. 2.

Next, shown in FIG. 9B is the status where the movable member 101a is withdrawn from the camera body. Print operation is performed by scanning the thermal head 420 while it is kept in contact with the thermal transfer ink film 201. The supply reel 221 still remains inside the movable member 110a in this status whereas the thermal head 420 scans on the printing frame 202 shown in FIG. 2 moving in the arrow direction. A complete printout of a photographed image is obtained by repeating the scanning four times to superimpose four discrete color images.

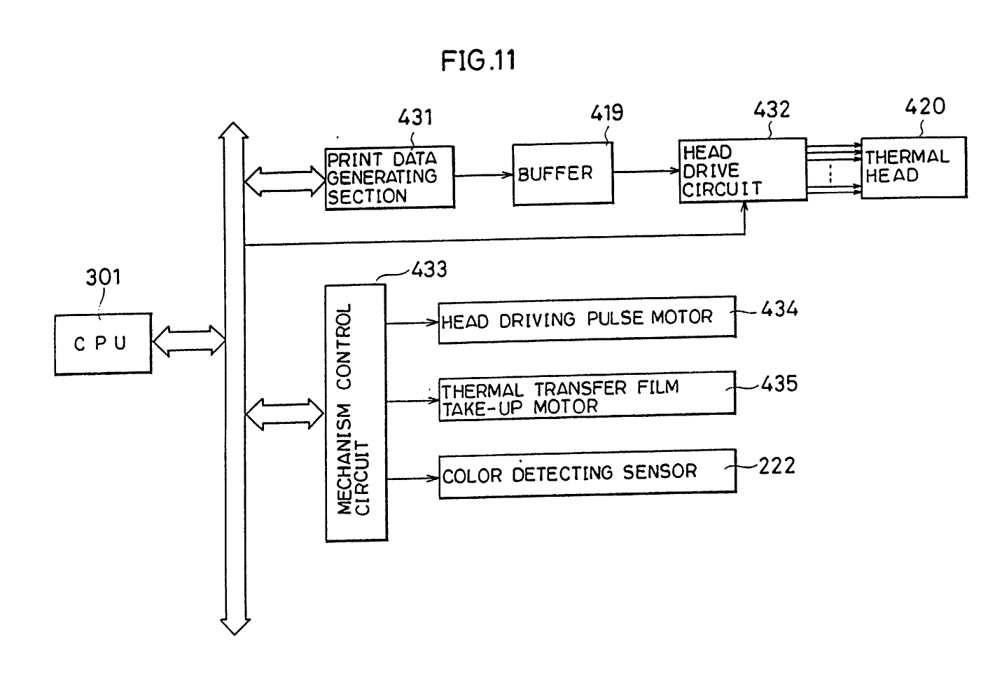

FIG. 11 is a block diagram to describe the construction and operation of the printer section.

Overall operation of this unit is controlled by CPU 301. Indicated at 431 is a print data generating section consisting of the afore-mentioned processor and line sequential access memory 418. As already described, parallel data of the bit number of one line is supplied from the line sequential access memory 418 to the buffer 419, where the data is converted into serial data and outputted to a head drive circuit 432. Using the output of the buffer 419, the head drive circuit 432 heats and drives the thermal head 420.

A mechanism control circuit 433 controls individual mechanical elements shown in FIGS. 9A and 9B based on the commands from CPU 301 and is connected to a head driving pulse motor 434 which drives the thermal head in its scanning direction, a thermal transfer film take-up motor 435 which drives the take-up reel 220 of the thermal transfer film 201, and the color detecting sensor.

Operation of individual circuits is described below referring to the above block diagram description.

Upon detecting that the printer section has been set to the print mode, CPU 301 transmits a print command signal to the head drive circuit 432. In accordance with the print command signal from CPU 301, the head drive circuit 432 produces a heating signal to be applied to the thermal head 420 by using one line of dot data received from the buffer 419 so that a cyan image of the first line is printed. Then the thermal head 420 is carried one line in the direction of an arrow shown in FIG. 2 on the printing frame by the head driving pulse motor 434. Printout of a complete image of the first color, or cyan, is accomplished by alternately printing a line of cyan and advancing the thermal head 420. Thereupon, CPU 301 activates the head driving pulse motor 434 to bring the thermal head 420 back to the reference position, or the first line, and causes the thermal transfer film take-up motor to take up the thermal transfer ink film 204 by the length of one color area to set to yellow. Printout of a complete yellow image is accomplished by alternately printing a line of yellow and advancing the thermal head 420 in the same way as above. A similar process is performed for magenta and black to reproduce a complete image by combination of colors. As already mentioned, it is also possible to sequentially print cyan, yellow, magenta and black for one line after another.

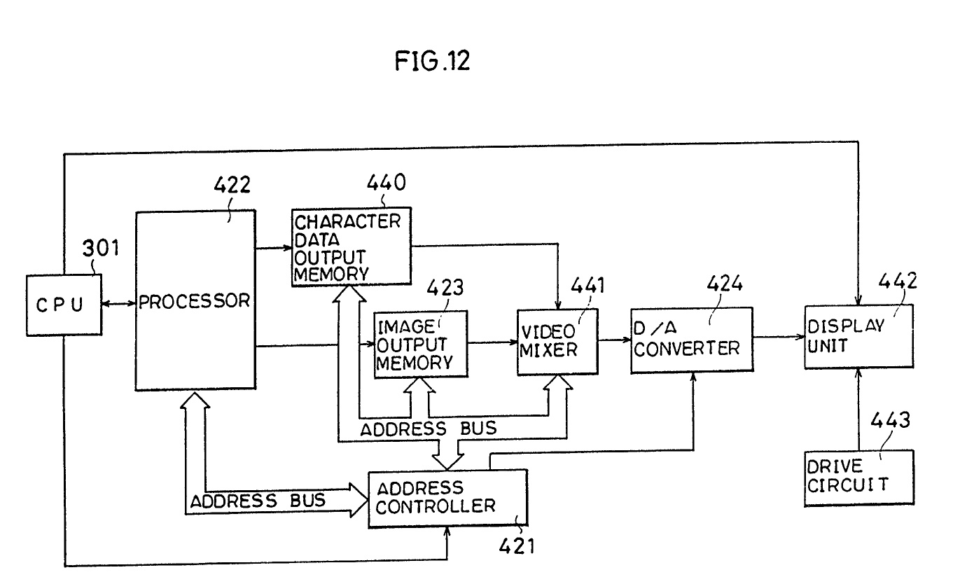

FIG. 12 is a block diagram of the circuitry that enables monitoring of an image on the display window 106.

Units identical to those shown in FIG. 6 carry the same part numbers in FIG. 12. Character data output memory 440 is a RAM, for example, in which various kinds of character data sent from CPU 301 such as frame number, print in process or print complete status to be shown on the display window 106 together with an image are written. A character generator may be used as a substitute for RAM to output appropriate character data according to command signals received from CPU 301.

The purpose of video mixer 441 is to generate a frame of image by combining the image output and character data output together. A display unit 442 includes a display window 106 as integral part. For example, the display unit 442 is an LCD TV monitor which monitors the input signal from D/A converter 424. A drive circuit 443 scans the screen of the display window 106 while applying a voltage to.individual elements of the LCD.

Since the display window 106 monitors an image when it is printed or reproduced on a TV screen, a stored image is presented on the display window 106 each time the access button ST or SW is turned on after the print mode detect switch SP or TV output switch SV has been turned on.

Before a specific image is reproduced, image data processed to be outputted to the TV is first stored in the image output memory 423. This image data comes from a memory area of a specific frame number in the IC card 2 or internal memory 405, whichever selected by the access button ST or SW.

On the other hand, on-screen alphanumeric data such as frame number, print in process or print complete status information received from CPU 301 is processed in the processor 422 and stored in the character data output memory 440. Then, the alphanumeric data outputted from the character data output memory 440 and the image data outputted from the image output memory 423 are combined into a single picture in the video mixer 441. As a result, each image is displayed with its frame number. The mixed image data is delivered through the D/A converter 424 to the display unit 442 for on-screen presentation. After the image has been presented on the display window 106 as explained above, the same image is printed through the afore-mentioned procedure.

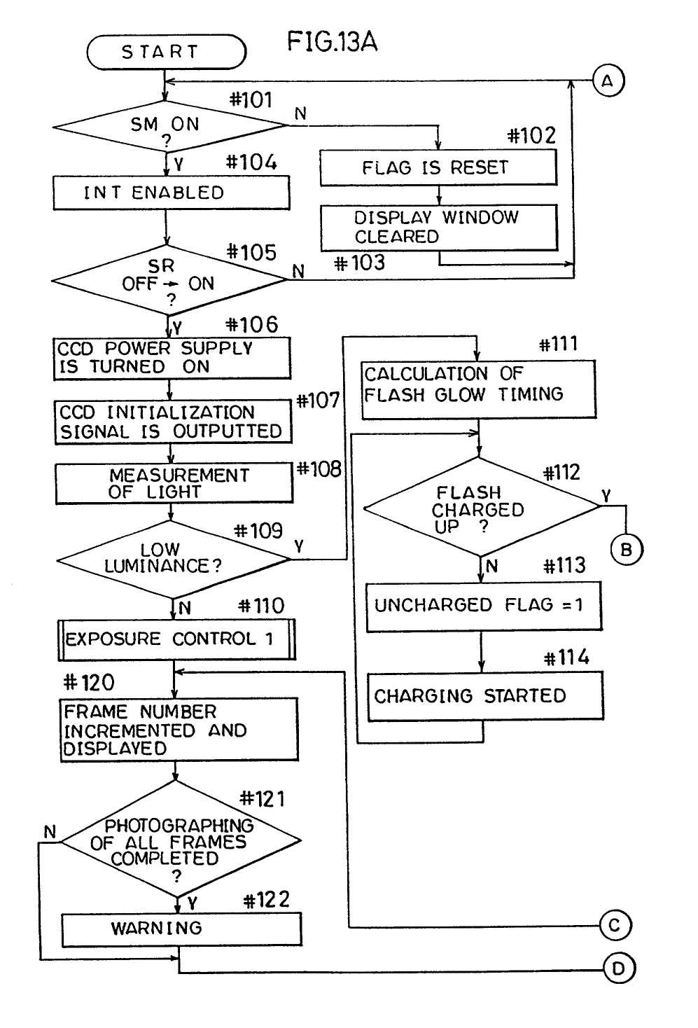

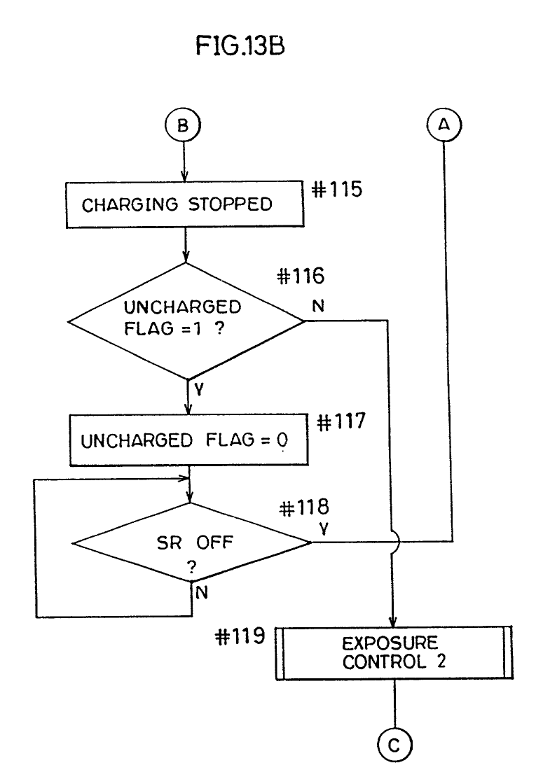

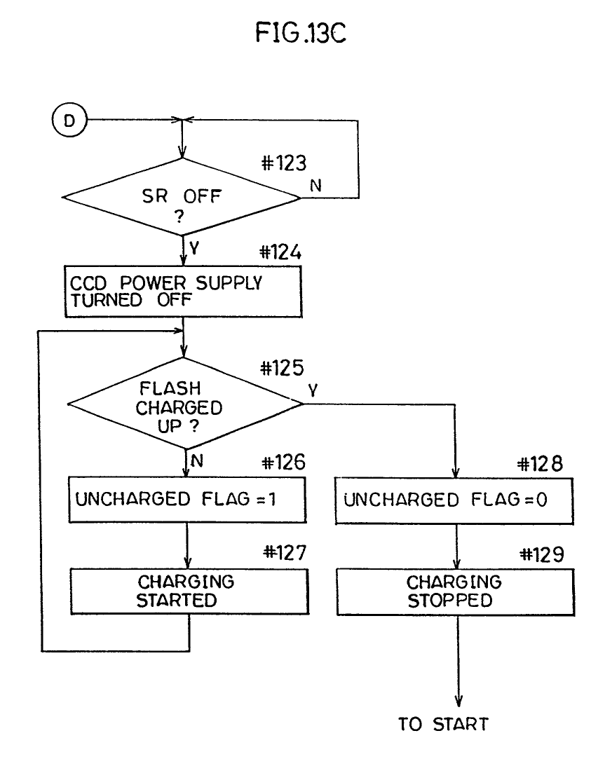

In addition to the above block diagram description of the camera, the following operational description of the camera mainly describes photographing operations referring to the flowcharts shown in FIGS. 13A through 17.

Operation of the camera 1 is controlled by CPU 301 and a program stored in a ROM (not illustrated) which is connected to CPU 301.

A START routine shown in FIGS. 13A, 13B, and 13C is executed when a power supply is mounted to the camera 1.

More specifically, the routine checks whether main switch SM is turned on at first (#101). If the main switch SM is turned off (No in step #101), the routine advances to step #102 to reset a flag. If any image is displayed on the display window 106, it is cleared (#103), and the routine returns to step #101 and waits until the main switch SM is turned on. When the main switch SM is turned on (Yes in step #101), or if it is already on when the power supply is mounted, the routine enables an interrupt (INT) described later (#104) and advances to step #105.

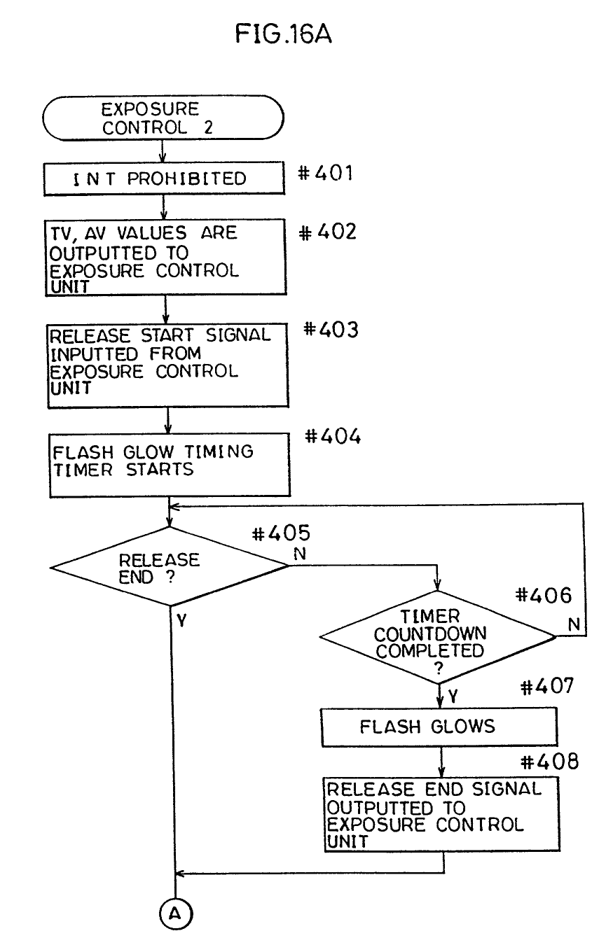

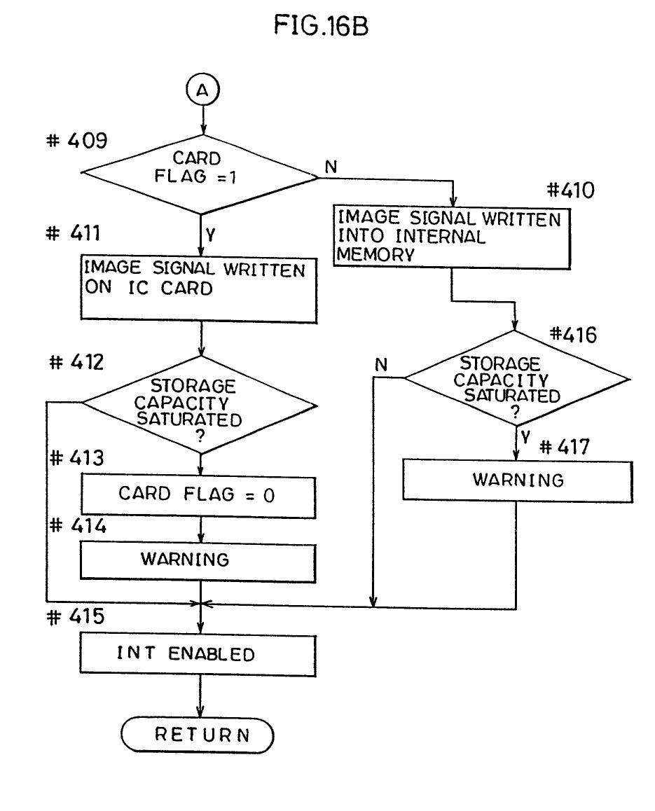

In step #105, the routine checks whether the start switch SR has been pressed to set it from the OFF to the ON status. If the start switch SR is not pressed (No in step #105), the routine returns to step #101, and repeats steps #101 through #104. If, however, the start switch SR is pressed (Yes in step #105), CCD 401 is powered on (#106). In short, the power supply unit 307 provides a high voltage VH to the CCD upon receiving a signal (P) sent from CPU 301 shown in FIG. 3. As soon as the power is supplied, a command signal is outputted to CCD-TG 402 to initialize CCD 401 so that residual charges in CCD 401 are removed (#107). Next, the light measuring unit 303 measures incident light in order to calculate exposure time TV and aperture setting value AV (#108). Also, the subject is checked to see if it is a low luminance object or not (#109) based on the light measurement data. In case the subject is judged to be a low luminance object (Yes in step #109), flash glow timing is calculated from the light measurement data (#111) in order to use the flash when photographing. Next, the routine checks whether a charging capacitor in the flash circuit 305 is already charged with sufficient electric energy. If it is not fully charged (No in step #112), an uncharged flag is set to 1 to start charging (#113, #114). The routine proceeds to step #115 upon completion of charging (Yes in step #112). Charging is stopped when it has been verified that the capacitor has been fully charged in step #115, and in step #116 it is determined if the uncharged flag is set to 1. If the uncharged flag has already been set to 1 (Yes in step 116), it is set to 0 in step #117 and the routine is kept standby until the start switch SR is turned off (#118). When the start switch SR is turned off (Yes in step #118), the routine returns to step #101 and a so-called release lock is carried out. On the other hand, if the uncharged flag is in 0 status in step #116, the routine proceeds to step #119 and a sub-routine titled “Exposure control 2” shown in FIG. 16 is executed.

Now, referring to FIG. 16, interrupt is prohibited in step #401 at first, and exposure time TV and aperture setting value AV calculated from the above-mentioned light measurement data are outputted to the exposure control unit 306 (#402). Based on these data, the exposure control unit 306 drives the diaphragm of the camera 1 and exposes CCD 401 by outputting a shutter control signal to CCD-TG 402 according to exposure time TV. When a signal indicating the start of release (start of exposure) has been received from the exposure control unit 306 (#403), the routine starts off its internal timer (#404) according to the flash glow timing obtained in step #111. The flash is designed to glow after a certain time has elapsed from the start of exposure of CCD 401. Next, the routine checks whether a release end signal has been received from the exposure control unit 306 (#405). This judgment is made because the above-mentioned exposure time TV is just an estimated value. If, for instance, the luminance of the subject suddenly increases while the flash glow timer is counting down, the exposure control unit 306 may output a release end signal even though the flash glow timing has not been reached. Accordingly, the purpose of the above process is to terminate the exposure operation without causing the flash to glow in case the exposure control unit 306 has outputted a release end signal (No in step #306 and Yes in step #405) before the flash glow timing is reached. In contrast, if the flash glow timing is reached before the release operation is completed (Yes in step #406), the flash is caused to glow and a release end signal is output to the exposure control unit 306 (#407, #408) to terminate the exposure operation.

When the above exposure process has been completed, the routine checks whether a card flag is set to the value “1” in step #409. If the value is “1” (Yes in step #409), the image signal read into CCD 401 is written on the IC card 2 mounted to the camera (#411). If the value is “0”, the image signal read into CCD 401 is written into the internal memory 405 of the camera 1 (#410). If, in the latter case, the storage capacity of the internal memory 405 is saturated (Yes in step #416), a visual or an audible warning is generated (#417). In the former case, the routine checks whether the storage capacity of the IC card 2 is saturated after the image signal has been written on the IC card 2. If it is saturated (Yes in #412), the card flag is set to “0” in step #413 while a warning is produced in step #414. Address of the internal memory 405 can be linked to that of the IC card 2 so that the photographer is alerted of saturation of the IC card 2 and the photographed image signal overflowing thereafter is written in the internal memory 405 instead of the IC card 2. On completing the above processes, the camera returns to the main routine after enabling interrupt in step #415.

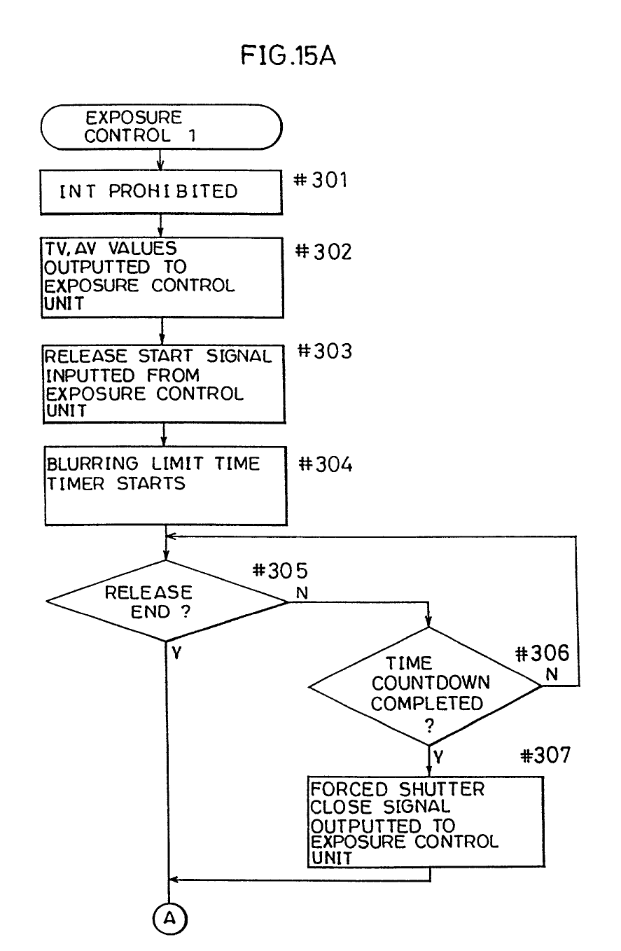

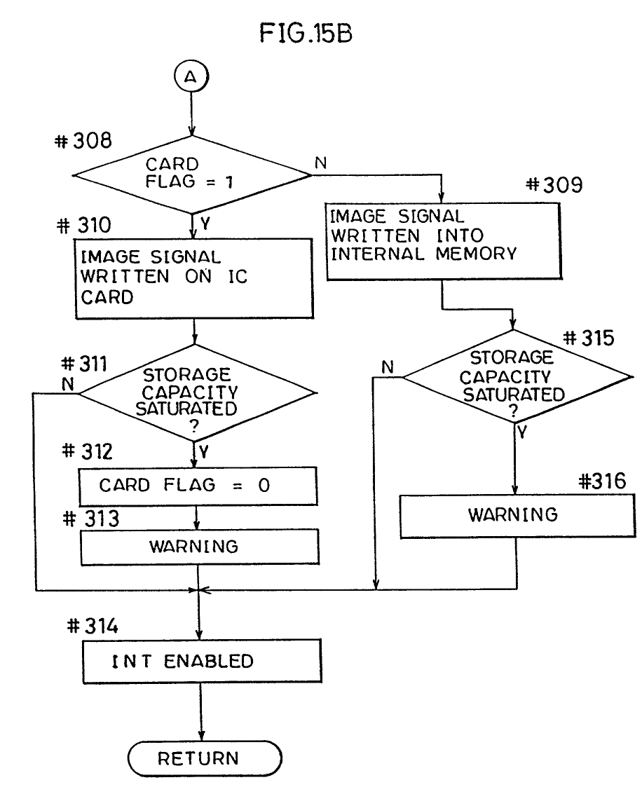

On the other hand, if the subject is judged to be a non-low-luminance object (No in step #109), a sub-routine shown in FIGS. 15A and 15B, in which the flash does not glow, is executed (#110).

Referring to FIGS. 15A and 15B, interrupt is prohibited in step #301 at first, and exposure time TV and aperture setting value AV calculated from the afore-mentioned light measurement data are output to the exposure control unit 306 (#302). Based on these data, the exposure control unit 306 drives the diaphragm of the camera 1 and exposes CCD 401 by outputting a shutter control signal to CCD-TG 402 according to exposure time TV. When a signal indicating the start of release (start of exposure) has been received from the exposure control unit 306 (#303), a timer is started to count a blurring limit time (#304). The blurring limit time, which defines the maximum exposure time within which photographing can be properly made without blurring, will count for much in case a relatively long exposure time is required. After the timer is started, the routine checks whether a release end signal has been output from the exposure control unit 306 (#305) while the timer is counting down as in the case of flash-assisted exposure explained earlier. If exposure time TV is reached (No in step #306) before the blurring limit time elapses, the exposure control unit 306 outputs a release end signal (Yes in step #305) to terminate the exposure operation. On the other hand, if the timer completes countdown before the release operation is finished (Yes in step #306), it is regarded that the blurring limit time has been reached and outputs a forced shutter close signal to the exposure control unit 306 (#307) to terminate the exposure operation.

When the above exposure process has been completed, the routine checks whether a card flag is set to the value “1” in step #308 in the same manner as steps #409 through #417 in the “exposure control 2” sub-routine. If the value is “1” (Yes in step #308), the image signal read into CCD 401 is written on the IC card 2 mounted to the camera (#310). If the value is “0”, the image signal read into CCD 401 is written into the internal memory 405 of the camera 1 (#309). If, in the latter case, the storage capacity of the internal memory 405 is saturated (Yes in step #315), a visual or an audible warning is generated (#316). In the former case, the routine checks whether the storage capacity of the IC card 2 is saturated after the image signal has been written on the IC card 2. If it is saturated (Yes in #311), the card flag is set to “0” in step #312 while a warning is produced in step #313. On completing the above processes, the routine returns to the main routine after enabling interrupt in step #314.

Now, referring again to the flowchart in FIG. 13, upon completing the exposure control sub-routine of step #110 or #119, the routine proceeds to step #120 where the frame number is incremented by one and displayed on the display window 106. When photographing of all the frames has been finished saturating the storage capacities of the IC card 2 and internal memory 405 (Yes in step #121), the photographer is alerted with a visual or an audible warning in step #122. If images can still be stored, warning will not be generated.

Then, the routine proceeds to step #123 and waits until start switch SR is turned off. When the start switch SR becomes OFF (Yes in step #123), CPU 301 outputs a signal (P) to turn off the power supply to CCD 401 and finish photographing of one frame (#124). After the above steps, the routine checks whether the flash is already charged with sufficient electric energy to perform subsequent photographing (#125). If it is not fully charged (No in step #115), an uncharged flag is set to “1” and charging is started to complete charging (#126, #127). When charging has been completed (Yes in step #125), the uncharged flag is set to “0” to stop charging (#128, #129). Thereupon, the routine returns to step #101 and repeats the same sequence as steps #101 through #129 explained above.

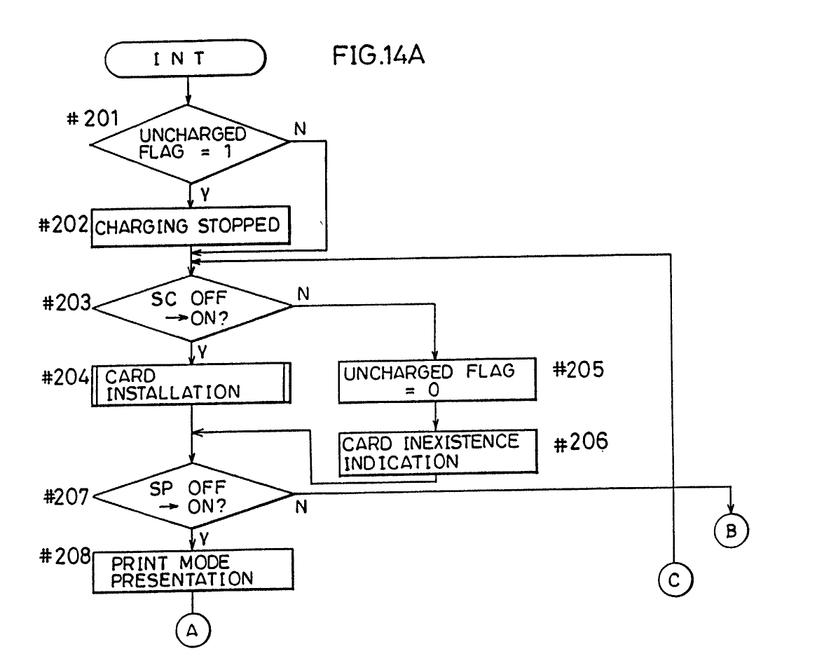

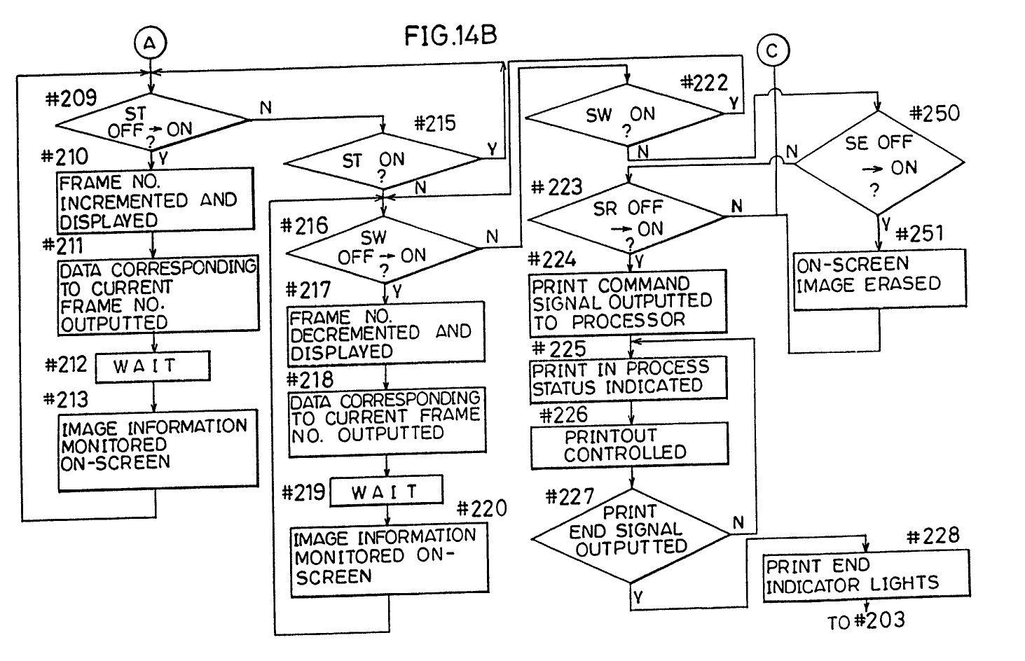

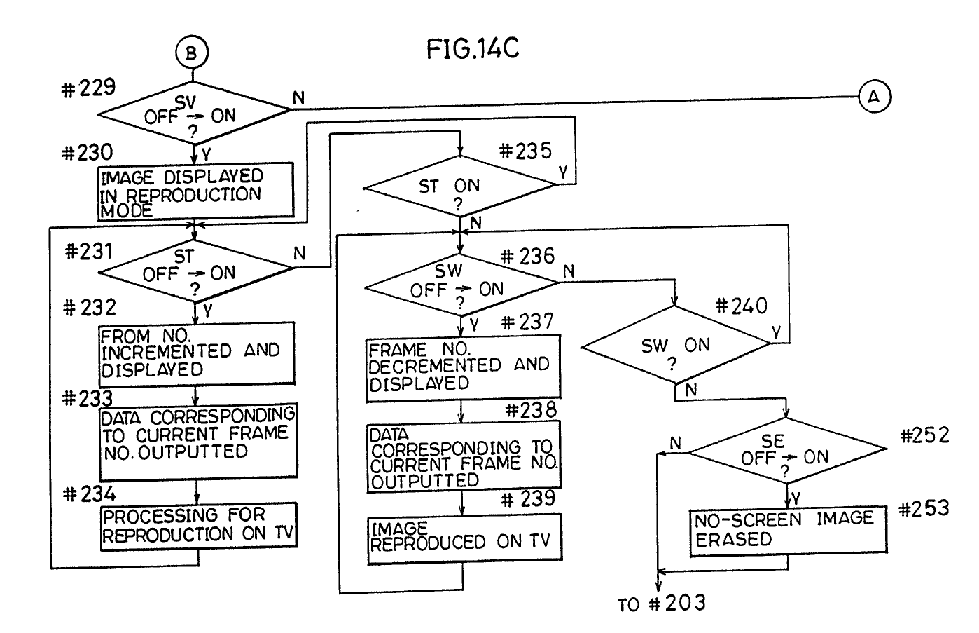

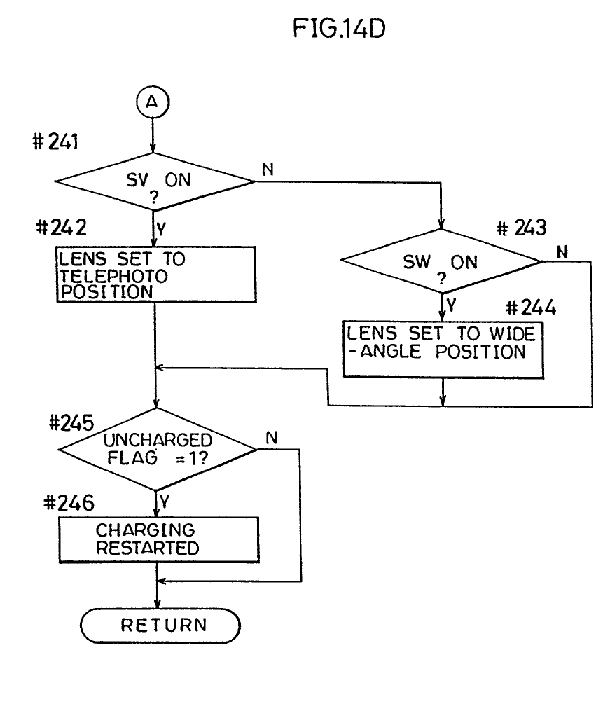

Referring to the flowcharts of FIGS. 14A through 14D, the following paragraph describes the sequence executed when an interrupt occurs after step #104 in which interrupt was enabled. An interrupt occurs when any of the following switches is turned on, SR which detects existence/inexistence of the IC card 2, SP which detects a transfer to the print mode, SV which requests reproduction of image on a TV screen, and access buttons ST and SW.

When an interrupt has taken place, the routine checks whether the uncharged flag has already been set to “1” in step #201. If the value is “1”, it is regarded that an interrupt occurred while the charging capacitor was being charged, and the chargeing process is halted. If the value is “0”, the routine skips step #202 and checks whether switch SC has changed from OFF status to ON status in step #203. If switch SC is still OFF (No in step #203), it is regarded that the IC card 2 is not plugged into the slot, and the card flag is set to “0” and an IC card inexistence indication is given (#205, #206).

On the other hand, when switch SC is set to ON (Yes in step #203), an IC card installation sub-routine shown at step #204 is executed.

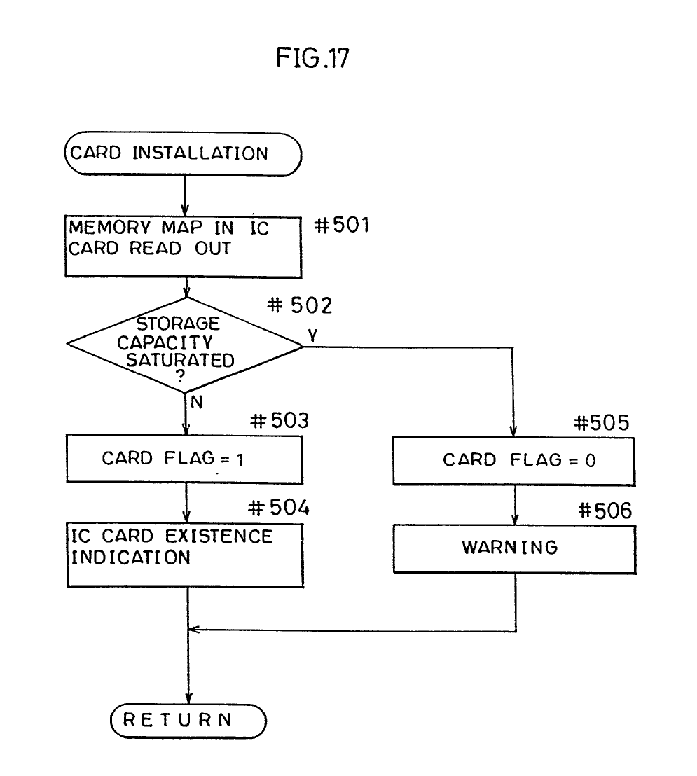

FIG. 17 shows a flowchart to explain the IC card installation sub-routine. In step #501 of this sub-routine, a memory map showing the status of image data storage in the IC card is read out to check that the storage capacity is already saturated, or that an excess memory area is available to store more image data. If there is space to store additional image data (No in step #502), the card flag is set to “1” and an IC card existence indication is given (#503, #504). If the memory capacity of the IC card 2 is already saturated (Yes in step #502), the card flag is set to “0” to give a warning to the photographer (#505, #506), and the routine returns to the main routine.

Now, returning to FIGS. 14A through 14D, the routine checks whether switch SP has been set from the OFF to the ON status. When switch SP is turned on to the ON status (Yes in step #207), the movable member 110a is withdrawn from the camera body. Then, the routine proceeds to step #208 regarding that the camera has been switched to the print mode. If switch SP is still in the OFF status (No in step #207), the routine proceeds to step #229. In step #208, the routine gives an indication that the camera is in the print mode and checks whether the access button ST has been pressed to set it from the OFF to the ON status (#209). The routine proceeds to step #210 when the access button ST is switched to the ON status (Yes in step #209), step #215 when the access button ST is kept in the OFF status or switched from the ON to the OFF status (No in step #209).

In step #210, the image is incremented one frame upward and it is presented on the display window 106 regarding that the access button ST has been pressed. On the other hand, the address controller 421 outputs the address data corresponding to the updated frame number in order to reproduce the image of the relevant frame number (#211). Waiting for a moment in step #212 while the above operations are carried out, the display window 106 monitors the image information corresponding to the current frame number (#213). Then, the routine returns to step #209, increments the frame number when the access button ST is pressed, and monitors the corresponding image on the display window 106. The routine repeats this sequence thereafter each time the access button ST is pressed. On the other hand, the routine checks whether the access button ST is in the ON status in step #215. the routine returns to step #209 if it is ON (Yes in step #215), proceeds to step #216 if it is OFF (No in step #215).

Next, the routine proceeds to step #217 when the access button SW is switched to the ON status (Yes in step #216) instead of the access button ST, step #222 when the access button SW is kept in the OFF status or switched from the ON to OFF status (No in step #216).

In step #217, the image is decremented one frame backward and it is presented on the display window 106 regarding that the access button SW has been pressed. On the other hand, the address controller 421 outputs the address data corresponding to the updated frame number in order to reproduce an image of the relevant frame number (#218). Waiting for a moment in step #219 while the above operations are carried out, the display window 106 monitors the image information corresponding to the current frame number (#220). Then, the routine returns to step #216, decrements the frame number when the access button SWT is pressed, and monitors the corresponding image on the display window 106. The routine repeats this sequence thereafter each time the access button SW is pressed. On the other hand, the routine checks whether the access button SW is in the ON status in step #222. The routine returns to step #216 if it is ON (Yes in step #222), proceeds to step #250 if it is OFF (No in step #222).

In step #250, it is checked whether the erasure switch SE has been turned on. When the erasure switch SE becomes ON (Yes in step #250), the rountine allows the image currently monitored on the display window 106 to erase from the IC card 2 or internal memory 405 (#251) and returns to step #203. If, however, the erasure switch SE is not turned on (No in step #250), the routine proceeds to step #223 and checks whether the start switch SR has been turned on.

If the start switch SR is not turned on (No in step #223), it is judged that printout is not required, then the routine returns to step #203 and repeats the above procedure. On the contrary, if the start switch SR is turned on (Yes in step #223), a print command signal is output to the processor in the unit 302 (#224) to start printout operation. On receiving this signal, the processor causes the printer section to start printing. On the other hand, the display window 106 shows “Print in Process” indication and controls the above-mentioned printout operation (#225, #226). Subsequently, the routine waits until the printout operation is completed in step #227 and a print end indicator is lit when a print end signal is output (Yes in step #227). After printing one frame of image through the above processes, the routine returns to step #203.

On the other hand, if the switch SP is not turned on in step #207, it is judged that printout is not required and the routine proceeds to step #229. More specifically, the routine checks whether the switch SV for reproduction on the TV has been turned on in step #229. If the switch SV for reproduction on the TV is OFF (No in step #229), it is judged that reproduction of image on the TV screen is not required and the routine proceeds to #241. On the contrary, if the switch SV for reproduction on the TV is turned on (Yes in step #229), the indication is provided which the reproduction mode is selected to reproduce an image on the TV (#230).

In this reproduction mode, the routine checks whether the access button ST or SW is pressed or not (#231, #236). When the access button ST is turned on (Yes in #231), the image is incremented one frame upward and it is presented on the TV screen. On the other hand, the address controller 421 outputs the address data corresponding to the updated frame number in order to reproduce the image of the relevant frame number (#232, #233). Subsequently, the TV monitors the image information corresponding to the current frame number (#234) in the same manner as explained earlier. Then, the routine returns to step #231, the frame number is incremented when the access button ST is pressed, and it is executed to monitor the corresponding image on the TV screen. The routine repeats this sequence thereafter each time the access button ST is pressed. On the other hand, the routine checks whether the access button ST is in the ON status in step #235. The routine returns to step #231 if it is ON (Yes in step #235), proceeds to step #236 if it is OFF (No in step #235).

Next, the routine proceeds to step #237 when the access button SW is switched to the ON status (Yes in step #236) instead of the access button ST, step #240 when the access button SW is kept in the OFF status or switched from the ON to OFF status (No in step #236).

In step #237, the image is decremented one frame backward and it is presented on the TV screen regarding that the access button SW has been pressed. On the other hand, the address controller 421 outputs the address data corresponding to the updated frame number in order to reproduce an image of the relevant frame number (#238). Subsequently, it is executed to monitor the image information corresponding to the current frame number (#239) on the TV screen in the same manner as explained earlier. Then, the routine returns to step #236, the frame number is decremented when the access button SWT is pressed, and it is executed to monitor the corresponding image on the TV screen. The routine repeats this sequence thereafter each time the access button SW is pressed. On the other hand, the routine checks whether the access button SW is in the ON status in step #240. The routine returns to step #236 if it is ON (Yes in step #240), proceeds to step #252 if it is OFF (No in step #240).

In step #252, it is checked whether the erasure switch SE has been turned on. When the erasure switch SE becomes ON (Yes in step #252), it is executed to erase the image currently monitored on the TV screen from the IC card 2 or internal memory 405 (#253) and the routine returns to step #203. If, however, the erasure switch SE is not turned on (No in step #252), the routine returns directly to step #203.

The sub-routine starting from step #241 checks the statuses of the access buttons ST and SW when in the photographing process, or when neither the print mode nor TV reproduction mode is selected. When the access button ST is turned on (Yes in step #241), the object lens 102 is set to the telephoto position (#242). When the access button SW is turned on (Yes in step #243), the object lens 102 is set to the wide-angle position (#244). If both the access buttons ST and SW are OFF, the object lens 102 is left at the present position. At the end of the above interrupt sequence, the routine checks whether the uncharged flag is set to “1” (#245). If the uncharged flag is set to “1”, the charging process is resumed (#246), which was interrupted when the interrupt occurred without fully charging the flash battery, and the routine returns to the main routine. If the uncharged flag is set to “0”, the routine directly returns to the main routine.

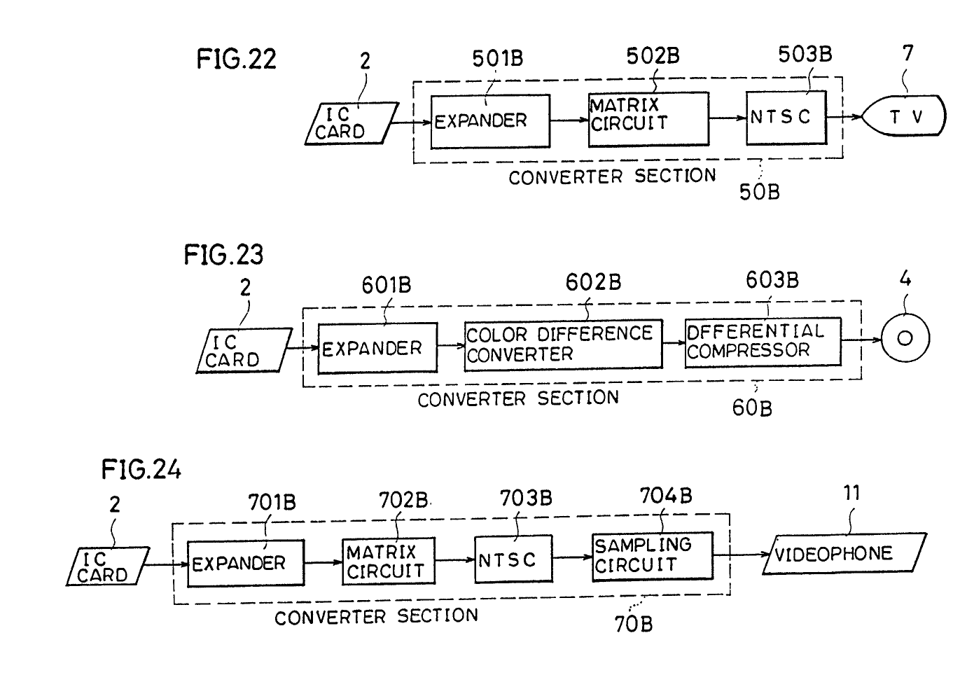

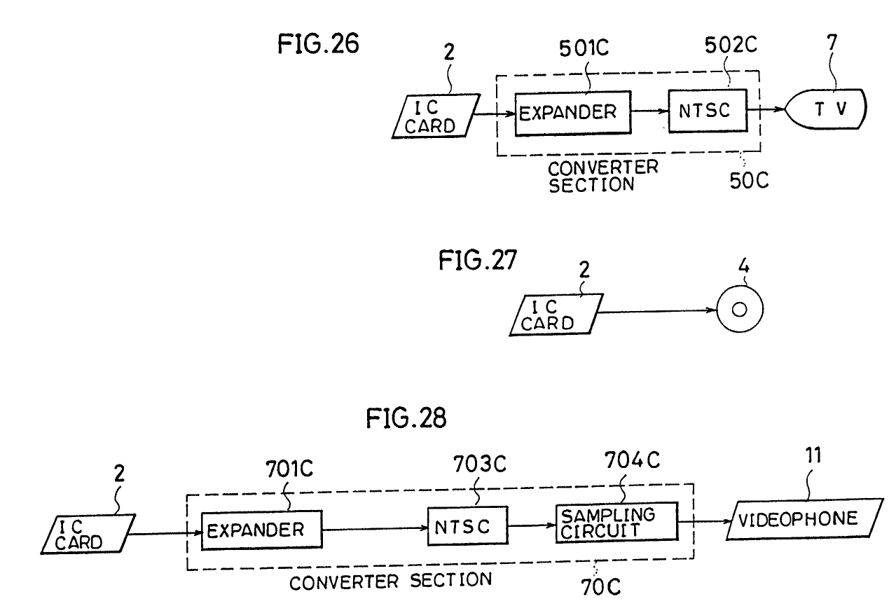

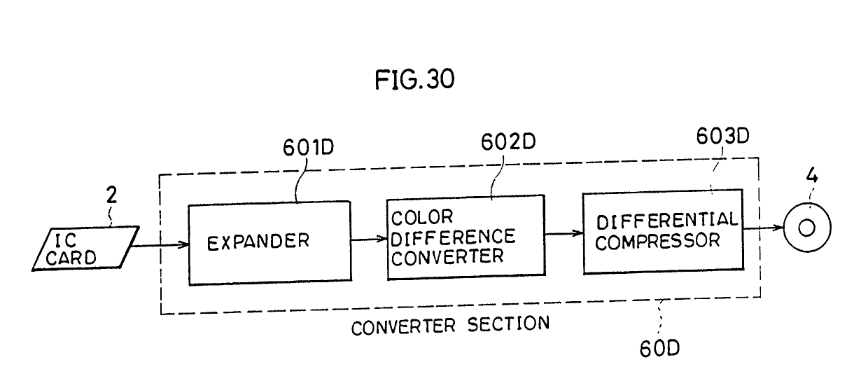

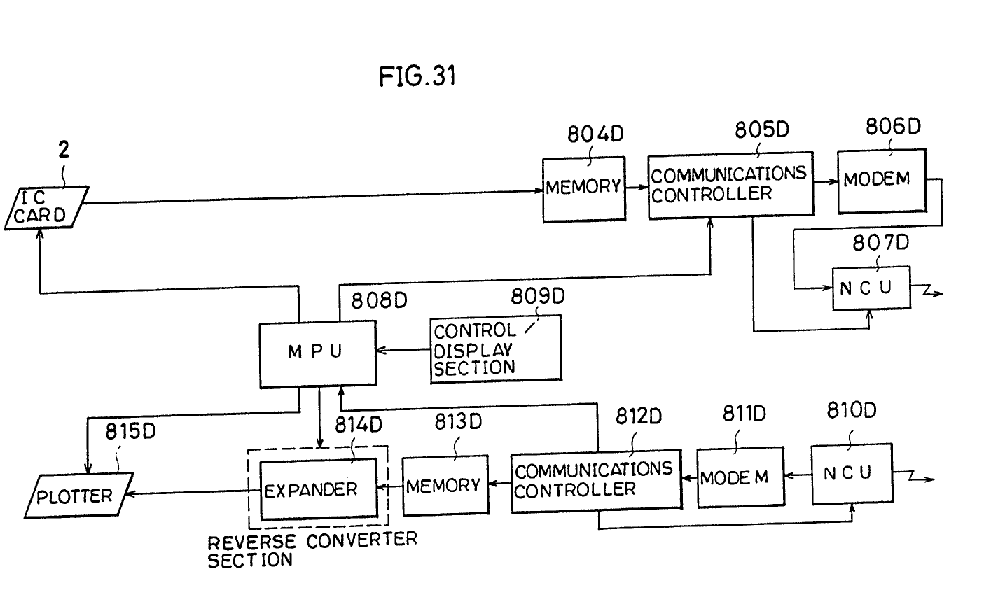

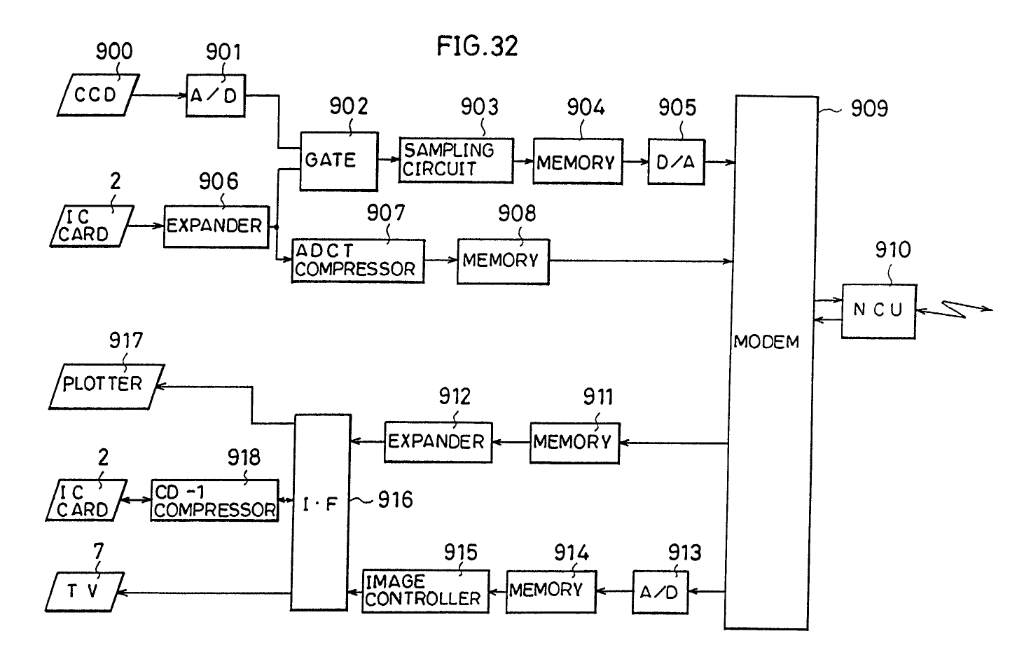

FIGS. 18 through 21 are block diagrams when recorded image data is an NTSC signal. FIG. 22 through 25 are block diagrams when recorded image data consists of RGB signals. FIG. 26 through 29 are block diagrams when recorded image data consists of color difference signals. FIGS. 30 and 31 are block diagrams when image data is recorded through an ADCT compression process instead of the CD I compression system. FIG. 32 is a block diagram showing a combination of a videophone and a facsimile machine.

First, referring to FIG. 18 showing how the image data stored on an IC card 2 is reproduced on a TV 7, indicated at 50A is a converter section incorporating an expander 501A which converts image data compressed by differential modulation back to the original image data by adding preceding values.

The image data is stored on the IC card 2 in the form of an NTSC signal compressed by differential modulation. Before outputting the image data to the TV 7, the expander 501A reconverts the differentially compressed data output from the IC card 2 to the original image data. Since the resultant output signal is already converted to an NTSC signal, it is directly output to the TV 7 for image reproduction.

In FIG. 19 showing how the image data stored on the IC card 2 is transferred to a CD ROM 4, indicated at 60A is a converter section which restores the original image data from the image data compressed by differential modulation and performs CD-I processing. The converter section 60A is made up of an expander 601A, a color difference converter 602A and a differential compressor 603A.

The image data is stored on the IC card 2 in the form of an NTSC signal compressed by differential modulation. The expander 601A reconverts the differentially compressed image data output from the IC card 2 back to the original image data. Then, the color difference converter 602A separates the luminance signal (Y) and color difference signal (C) from the expanded image data. The luminance signal (Y) and the color difference (C) go through another differential compression process, or so-called CD-I processing, in the succeeding differential compressor 603A before they are written on the CD-ROM 4.

In FIG. 20 showing how the image data stored on the IC card 2 is output to a videophone 11, indicated at 70A is a converter section which restores the original image data from the image data compressed by differential modulation and performs data sampling. The converter section 70A is made up of an expander 701A and a sampling circuit 702A.

The image data is stored on the IC card 2 in the form of an NTSC signal compressed by differential modulation. The expander 701A reconverts the differentially compressed data output from the IC card 2 to the original image data. Since the image data is an NTSC signal, the image data may be directly fed to a TV. However, in the present preferred embodiment, it is processed through the sampling circuit 702A for appropriate sampling in consideration of the transmission capacity of the phone line before it is output to the videophone 11. The sampling circuit 702A may be eliminated, however, when utilizing an ISDN (Integrated Service Digital Network) in place of the phone line.

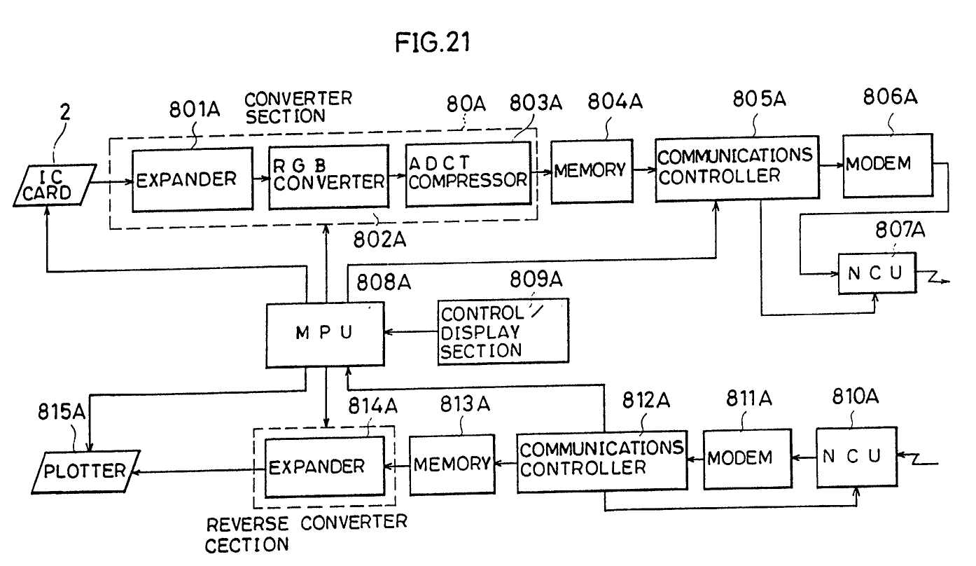

FIG. 21 is a block diagram showing how the image data stored on the IC card 2 is output by means of a fax machine 10. Indicated at 80A is a converter section in which the image data compressed by differential modulation is converted back to the original image data, reconverted to RGB signals and then compressed again. The converter section 80A is made up of an expander 801A, an RGB converter 802A and an ADCT compressor 803A.

MPU 808A controls overall operation of this unit as well as flows of the image information, communications, network control, etc. The RGB converter 802A converts the original image data obtained through expansion of the compressed data to RGB color signals. The ADCT compressor 803A performs a sort of transform coding according to the IS0/JTC1/SC2/WG8 N800 standards, in which the image signal is converted through an orthogonal transform process to sample multiple signal components from low to high frequencies. To accomplish data compression, the number of sampling bits is reduced as the frequency of signal components increases in the light of the fact that correlation between the original signal and sampled data generally lessens with the increase of frequency. Since the image data is separated into frequency components, the number of sampling bits of not only the high frequency components but also any specific frequency component can be reduced in this process. An image is divided into units comprising an appropriate number of picture elements and a series of numerals consisting of sampled values of each unit is converted through orthogonal transform. In this preferred embodiment of the invention, the ADCT compressor 803A breaks the image data into units of 8×8 picture elements and then orthogonalizes them by two-dimensional DCT (Discrete Cosine Transform). Compared to the original sampled values, individual terms obtained through orthogonal transform become more independent (or unaffected by other terms) so that the process suppresses the redundant information.

A memory 804A is used as a TX buffer and communications controller 805A controls a facsimile transmission sequence as appropriate to enable image data transfer to a remote facsimile machine. A modem 806A is provided to modulate the digital data so that an analog public telephone line can be used for data transmission. In this preferred embodiment, the ADCT compression signal is modulated in order to transmit the image data through a videophone line. When the image data is transmitted through an ISDN, the modem is replaced with an appropriate type. NCU 807A interfaces the facsimile machine 10 with the public telephone line network when transmitting an image while NCU 810A interfaces the facsimile machine 10 with the public telephone line network when receiving an image. Modem 811A is provided to demodulate the analog signal to digital data. Like communications controller 805A, communications controller 812A controls a facsimile reception sequence as appropriate enable image data transfer from a remote facsimile machine. A memory 813A is used as an RX buffer. An expander 814A restores the original image data by reverse conversion of the input image data converted through ADCT compression. A plotter 815A prints out the received facsimile image. Provided with various control keys and a display window, control/display section 809A presents operating instructions and allows an operator to enter key inputs. For the convenience of explanation, the memories 804A ad 813A, communications controllers 805A and 812A, modems 806A and 811A, and NCUs 807A and 810A are shown individually for transmission and reception in FIG. 21. These can be shared for transmission and reception in an actual system rather than duplicating the same elements.

With reference to the above block diagram description, transmission and reception operations are individually described in the following.

The image data is stored on the IC card 2 in the form an NTSC signal compressed by differential modulation. The expander 801A reconverts the differentially compressed data output from the IC card 2 back to the original image data. The RGB converter 802A produces RGB color signals from this differentially compressed image data. The RGB signals are compressed by the ADCT compressor 803A provided at the next stage and written in the memory 804A. Then, the communications controller 805A transfers the image data stored in the memory 804A to a remote facsimile machine via NCU 807A.

On the other hand, upon receiving a call signal from a remote facsimile machine, the communications controller 812A activates NCU 810A to connect the line. Consequently, the incoming image data which is converted by an ADCT system passes through NCU 810A and is demodulated by the modem 811A. The demodulated image data is then written in the memory 813A. The image data stored in the memory 813A is sequentially read out and reversely converted by the expander 814A back to the original image data, which is finally printed out by the plotter 815A.

Next, in FIG. 22 showing how the image data stored on the IC card 2 is reproduced on a TV, indicated at 50B is a converter section in which the image data compressed by differential modulation is converted back to the original image data and reconverted to an NTSC signal. The converter section 50B is made up of an expander 501B, a matrix circuit 502B and an NTSC converter 503B.

The matrix circuit 502B performs matrix processing shown in FIG. 7 (#13-#19) and the NTSC converter 503B converts the RGB signals to the NTSC signal for the TV.

The image data is stored on the IC card 2 in the form of RGB signals compressed by differential modulation. The expander 501B outputs the image data after restoring the original image data from the differentially compressed data fed from the IC card 2. The resultant output signal undergoes matrix processing and NTSC conversion and delivered to the TV 7 for image reproduction.

FIG. 23 showing how the image data stored on the IC card 2 is transferred to a CD-ROM 4, indicated at 60B is a converter section which restores the original image data from the image data compressed by differential modulation and performs CD-I processing. The converter section 60B includes an expander 601B, a color difference converter 602B and a differential compressor 603B.

The image data is stored on the IC card 2 in the form of RGB signals compressed by differential modulation. The expander 601B reconverts the differentially compressed image data output from the IC card 2 back to the original image data. Then, the color difference converter 602B separates the luminance signal (Y) and color difference signal (C) from the expanded image data. The luminance signal (Y) and the color difference (C) go through another differential compression process, or so-called CD-I processing, in the succeeding differential compressor 603B before they are written on the CD-ROM 4.

In FIG. 24 showing how the image data stored on the IC card 2 is output to a videophone 11, indicated at 70B is a converter section which restores the original image data from the image data compressed by differential modulation, converts it to an NTSC signal and then performs data sampling. The converter section 70B is made up of an expander 701B, a matrix circuit 702B, an NTSC converter 703B and a sampling circuit 704B.

The image data is stored on the IC card 2 in the form of an NTSC signal compressed by differential modulation. The expander 701B reconverts the differentially compressed data output from the IC card 2 back to the original image data. Matrix processing and NTSC conversion are applied to the output signal of the expander 701B to convert it into a form suitable for a TV. The resultant signal is delivered to the sampling circuit 704B for appropriate sampling of the luminance signal and then transferred via the videophone 11. As already explained, the sampling circuit 704B may be eliminated when utilizing an ISDN.

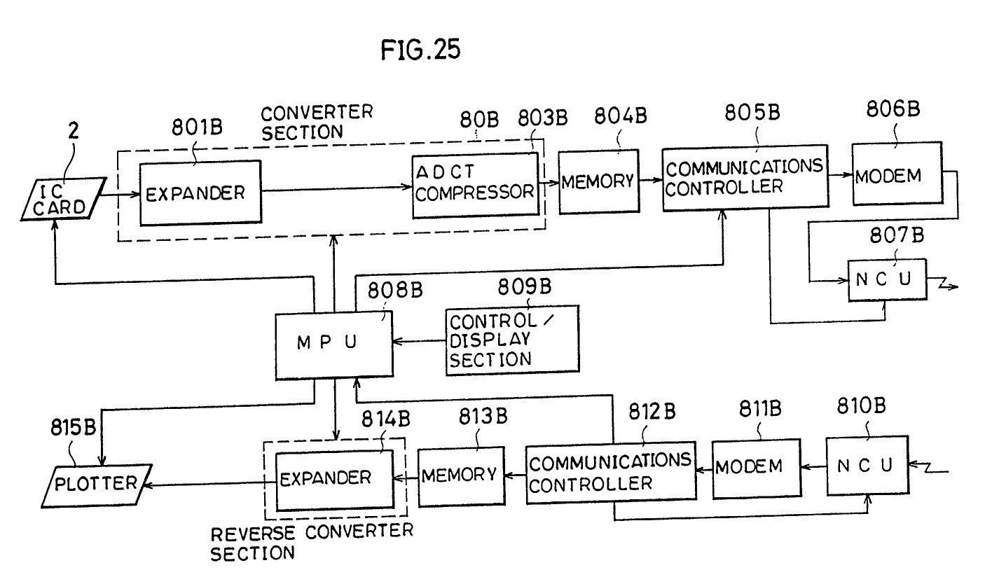

In FIG. 25 showing how the image data stored on the IC card 2 is output by using a facsimile machine 10, indicated at 80B is a converter section in which the image data compressed by differential modulation is converted back to the original image data and compressed again. The converter section 80B is made up of an expander 801B and an ADCT compressor 803B.

This unit is identical to the unit shown in FIG. 21 except that the RGB converter 802A is not provided. Operation of each individual circuit is same as described with reference to FIG. 21.

Given below is a brief operational description of this unit.

The image data is stored on the IC card 2 in the form RGB signals compressed by differential modulation. The expander 801B reconverts the differentially compressed data output from the IC card 2 to the original image data. The RGB signals are compressed by the ADCT compressor 803B provided at the next stage and written in the memory 804B. Then, the communications controller 805B transfers the image data stored in the memory 604B to a remote facsimile machine via NCU 807B.

On the other hand, upon receiving a call signal from a remote facsimile machine, a communications controller 812B activates a NCU 810B to connect the line. Consequently, the incoming image data which is converted by an ADCT system passes through the NCU 810B and is demodulated by a modem 811B and written in the memory 813B. The image data stored in the memory 813B is sequentially read out and reversely converted by an expander 814B back to the original image data, which is finally printed out by a plotter 815B.

Next, in FIG. 26 showing how the image data stored on the IC card 2 is reproduced on a TV, indicated at 50C is a converter section in which the image data compressed by differential modulation is converted back to the original image data and reconverted to a NTSC signal. The converter section 50C is made up of an expander 501C and a NTSC converter 502C.

The image data is stored on the IC card 2 in the form of color difference signals compressed by differential modulation. The expander 501C outputs the image data after restoring the original image data from the differentially compressed data fed from the IC card 2. Already converted to color difference signals, this output signal is converted to a NTSC signal and delivered to the TV 7 for image reproduction.

In FIG. 27 showing how the image data stored on the IC card 2 is transferred to a CD-ROM 4, the image data is stored on the IC card 2 in the form of color difference signals compressed by differential modulation and, therefore, the differentially compressed data output from the IC card 2 is directly written on the CD-ROM 4.

FIG. 28 showing how the image data stored on the IC card 2 is output to a videophone 11, indicated at 70C is a converter section which restores the original image data from the image data compressed by differential modulation, converts it to a NTSC signal and then performs data sampling. The converter section 70C is made up of an expander 701C, an NTSC converter 703C and a sampling circuit 704C.

The image data is stored on the IC card 2 in the form of color difference signals compressed by differential modulation. The expander 701C reconverts the differentially compressed data output from the IC card 2 back to the original image data. NTSC conversion is applied to the output signal of the expander 701C to convert it into a form suitable for a TV. The resultant signal is delivered to the sampling circuit 704C for appropriate sampling of the luminance signal and then transferred via the videophone 11. As already explained, the sampling circuit 704C may be eliminated when utilizing an ISDN.

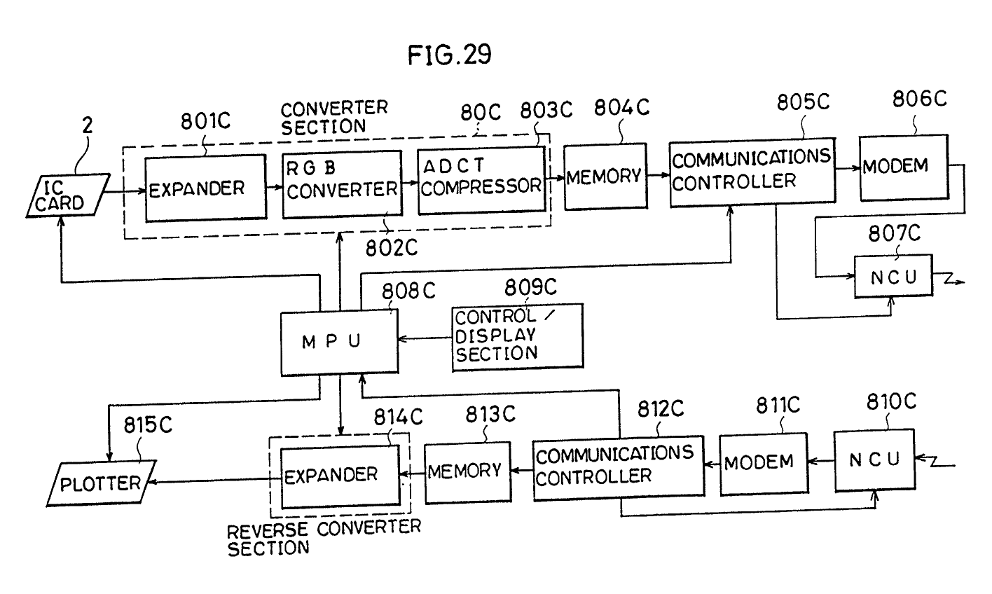

FIG. 29 showing how image data stored on the IC card 2 is output by means of a facsimile machine 10, indicated at 80C is a converter section in which the image data compressed by differential modulation is converted back to the original image data, reconverted to RGB signals and then compressed again. The converter section 80C is made up of an expander 801C, an RGB converter 802C and an ADCT compressor 803C.

This block diagram is similar to the block diagram shown in FIG. 21.

Given below is a brief operational description of this unit.

The image data is stored on the IC card 2 in the form color difference signals compressed by differential modulation. The expander 801C reconverts the differentially compressed data output from the IC card 2 back to the original image data. The RGB converter 802C produces RGB signals from the color difference signals. The RGB signals are compressed by the ADCT compressor 803C provided at the next stage and written in the memory 804C. Then, communications controller 805C transfers the image data stored in memory 804C to a remote facsimile machine via NCU 807C.

On the other hand, upon receiving a call signal from a remote facsimile machine, communications controller 812C activates NCU 810C to connect the line. Consequently, the incoming image data which is converted by an ADCT system passes through NCU 810C and is demodulated by modem 811C. The demodulated image data is then written in memory 813C. The image data stored in the memory 813C is sequentially read out and reversely converted by expander 814C back to the original image data, which is finally printed out by a plotter 815C.

FIG. 30, corresponding to FIG. 19, shows how the image data stored on the IC card 2 processed by an ADCT compression system is transferred to a CD-ROM 4.

As explained earlier, the ADCT compression system performs data compression by reducing the number of sampling bits as the frequency of signal components increases in the light of the fact that correlation between the original signal and sampled data generally lessens with the increase of frequency.

Indicated at 60D is a converter section which restores the original image data from the image data differentially compressed by the ADCT compression system and performs CD-I processing. The converter section 60D is made up of an expander 601D, a color difference converter 602D and a differential compressor 603D.

The image data is stored on the IC card 2 in the form of an NTSC signal compressed by differential modulation. The expander 601D reconverts the differentially compressed image data output from the IC card 2 back to the original image data. Then, the color difference converter 602D separates the luminance signal (Y) and color difference signal (C) from the expanded image data. The luminance signal (Y) and the color difference (C) go through another differential compression process, or so-called CD-I processing, in the succeeding differential compressor 603D before they are written on the CD-ROM 4.

FIG. 31, corresponding to FIG. 20, shows how the image data stored on the IC card 2 processed by an ADCT compression system is output by means of a facsimile machine 10.

The converter section is not required in this unit because the image data is stored on the IC card 2 in the form of RGB signals differentially compressed by the ADCT compression svstem. The image data read out of the IC card 2 is directly transmitted and written into memory 804D. Then, communications controller 805D transfers the image data stored in the memory 804D to a remote facsimile machine via NCU 807D.

On the other hand, upon receiving a call signal from a remote facsimile machine, communications controller 812D * activates a NCU 810D to connect the line. Consequently, the incoming RGB image data which is converted by the ADCT system passes through a NCU 810D. Next, it is demodulated by a modem 811D and written in a memory 813D. The image data stored in the memory 813D is sequentially read out and reversely converted by expander 814D back to the original image data, which is finally printed out by a plotter 815D.

As described in the above explanation, the IC card 2 storing the image data processed through ADCT compression can be adapted to a system in which the image data is reproduced on the TV 7 (as described in FIG. 18), output to the videophone 11 (as described in FIG. 20), or output via the facsimile machine 10 (as described in FIG. 21) as the case may be. Furthermore, the IC card 2 can be adapted not only when the image data is recorded in the form of an NTSC signal but also RGB signals (as described in FIGS. 22 to 25), color difference signals (as described in FIGS. 26 to 29) and in FIG. 32 as described below. Except when outputting the image data via the facsimile machine 10, the above unit employs an expander which restores the original image data from the data processed through ADCT compression.

FIG. 32 showing a combination of a videophone and a facsimile machine.

Given below at first is a description of the unit shown in FIG. 32 when it functions as a videophone.

There are two alternative sources from which image data is transferred to the videophone 11. it may be picked up by an internal CCD 900 or read out of an IC card 2. Before outputting the image data, gate 902 which is controlled by a controller not shown in the block diagram switches between the two image signals.

When transferring the image signal derived from the CCD 900, an A/D converter 901 converts the image signal into digital data and delivers it to the gate 902. The resultant digital data is sampled by a sampling circuit 903 as appropriate and temporarily written in a memory 904 which functions as a TX buffer. The output data of the memory 904 is converted into an analog signal by a D/A converter 905, modulated to a signal suitable for the phone line by a modem 909 and sent out to the phone line via a NCU 910 which controls interfacing with the network. When transferring the image signal read out of the IC card 2, the differentially compressed image data is expanded by an expander 906 to restore the original image data and delivered to the gate 902. The image data is then sampled as appropriate and temporarily written in the memory 904 in the same manner as described above. The output data of the memory 904 is converted into an analog signal, modulated to a signal suitable for a phone line and sent out to the phone line via the NCU 910 which controls interfacing with the network.

On the other hand, reception of the image signal is performed as follows. The image signal received through the NCU 910 is demodulated by the modem 909 at first. Then, the demodulated signal is converted into a digital form by an A/D converter 913 and temporarily written in a memory 914 which functions as an RX buffer. The digital data output from the memory 914 is sequentially processed through expansion and various kinds of signal processing taking account of the image size, etc. before it is led to an interface 916. The output data of the interface 916 is sent to the TV 7 for image reproduction as appropriate, or recorded on the IC card 2 after differential compression process conducted by a CD-I compressor 918. Received image data is temporarily recorded on the IC card 2 in such a manner whenever required, allowing reproduction of the image on the TV, printout, and transfer to another storage medium as the need arises.

Next, when the unit shown in FIG. 32 functions as a facsimile machine, the gate 902 does not operate and the image data read out of the IC card 2 is sent to the NCU 910 through the line consisting of an ADCT compressor 907 and a memory 908. More specifically, the differentially compressed image data read from the IC card 2 is converted back to the original image data by the expander 906, compressed again to suit a facsimile machine by the ADCT compressor 907, and temporarily stored in the memory 908. In this connection, if the image data recorded in the IC card 2 is compressed by an ADCT system, the expander 906 and the ADCT compressor 907 may be omitted as stated above. Using the memory 908 as a TX buffer, the image data is output to the modem 909, modulated to suit the phone line and sent out to the phone line via the NCU 910.

On the other hand, at reception of image data, the image signal received through the NCU 910 is demodulated by the modem 909 and temporarily written in a memory 911 which functions as an RX buffer. As this image signal is processed through differential compression, it is returned to the original image data by an expander 912 and led to the interface 916. The output data of the interface 916 is sent to a plotter 917 to print out the image as appropriate, or recorded on the IC card 2 after a differential compression process conducted by the CD-I compressor 918. Received image data is temporarily recorded on the IC card 2 in such a manner whenever required, allowing reproduction of the image on the TV, printout, and transfer to another storage medium as the need arises.

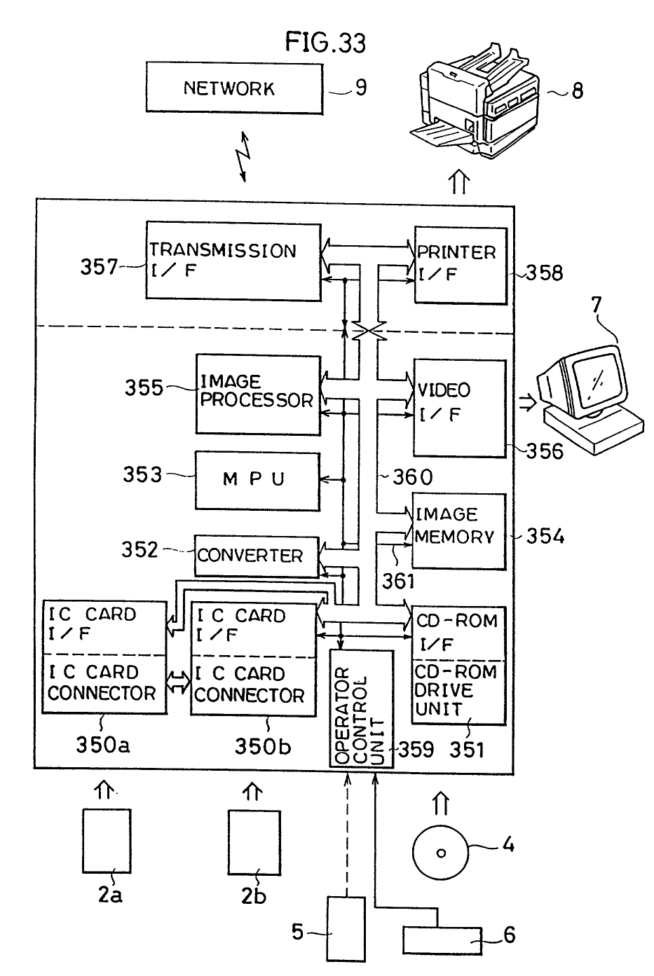

FIG. 33 is a block diagram of the CD-ROM driver 3 shown in FIG. 1.

Indicated at 350a and 350b are interfaces for reading or writing the image information from or to the IC cards 2a and 2b when they are mounted to the CD-ROM driver 3. The interfaces 350a, 350b includes connectors respectively. Furthermore, the image information can be transferred between the IC cards through these interfaces. Indicated at 351 is a CD-ROM interface unit for recording or reading the image information on or from the CD-ROM 4. The CD-ROM interface unit 351 includes a CD-ROM drive unit.

Indicated at 352 is a converter which carries out data compression and expansion so that the image information stored on the IC card 2a or 2b can be transferred and recorded onto the CD-ROM 4. Contrary to this, the converter 352 also performs signal processing when transferring the image information stored on the CD-ROM 4 to the IC card. Indicated at 353 is a microcomputer (hereinafter called the MPU) which controls the whole unit of the CD-ROM driver 3. Indicated at 354 is an image memory in which the image information is written temporarily. Indicated at 355 is an image processor which reproduces the image or generates menu screens to be described later during reproduction of the image information on the TV 7, printer 8, or remote reproduction equipment such as a videophone or a facsimile machine. Indicated at 356 is an interface which processes and outputs the image information to the TV 7 so that the image can be properly reproduced on the TV 7.

Indicated at 357 is a transmission interface which performs signal processing such as compression or expansion so that the image information can be transmitted through the network. Indicated at 358 is a printer interface which also performs signal processing so that the image can be printed by the printer 8. The above-mentioned transmission interface 357 and printer interface 358 may either be added to the CD-ROM driver 3 as extra function expansion units to upgrade the system features or incorporated as standard in the CD-ROM driver 3.

Indicated at 359 is an operator control unit provided at the front panel of the CD-ROM driver 3. Information entered from operation switches, remote controller 5 and keyboard 5 is conveyed to the MPU 353 through this unit. It is also possible to control the interfaces 350a, 350b by operating the operator control unit 359 so that images can be copied between the IC cards 2a and 2b as described earlier. In this unit, the image information is exchanged via an image data bus 360 and individual elements of the unit is controlled by a control data bus 361.

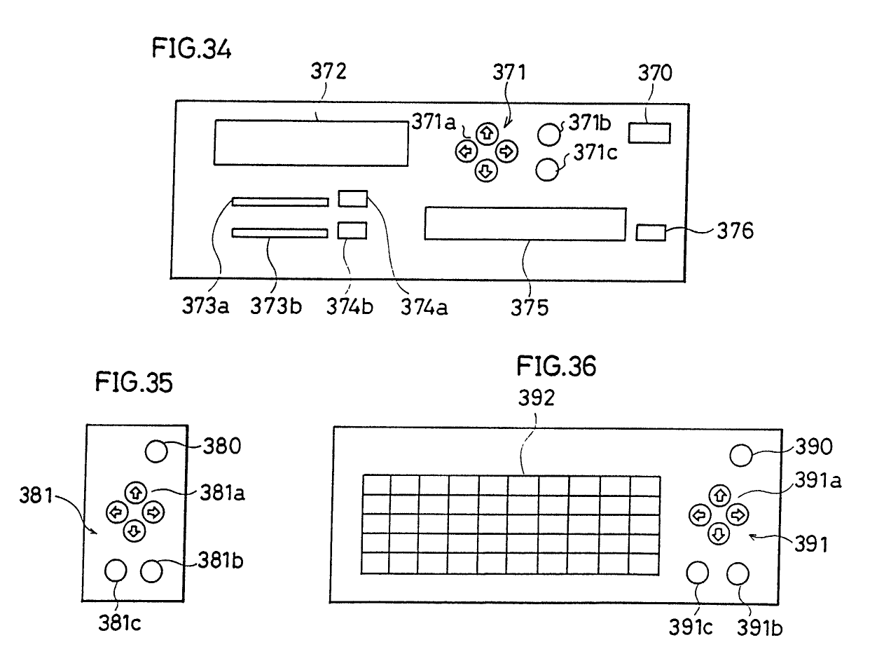

FIG. 34 shows an operating panel of the operator control unit 359 provided on the front panel of the CD-ROM driver 3.

Indicated at 370 is a power switch which supplies electric power to the whole CD-ROM driver 3 when turned on. Indicated at 371 are function keys consisting of cursor keys 371a, an enter key 371b and a clear key 371c used during reproduction, retrieval of image data, etc. on the TV 7 or other devices. Indicated at 372 is an indicator which displays the operating status when the image is being reproduced or printed out or during other operations. Indicated at 373a and 373b are slots in which the IC cards 2a and 2b are inserted respectively. Indicated at 374a and 374b are eject switches used to remove the IC cards 2a and 2b out of the slots. Indicated at 375 is a slot for the CD-ROM 4, indicated at 376 is an eject switch used to remove the CD-ROM 4.

FIG. 35 shows an operating panel of a remote controller 5. Indicated at 380 in FIG. 35 is a power switch. Indicated at 381 are function keys consisting of a cursor key 381a, an enter key 381b and a clear key 381c which have the same functions as the function keys 371 shown above in FIG. 34.

FIG. 36 shows an operating panel of a keyboard 6. Indicated at 380 in FIG. 36 is a power switch, indicated at 391 are function keys consisting of a cursor key 391a, an enter key 391b and a clear key 391c which have the same functions as the function keys 371 shown above in FIG. 34. Indicated at 392 are character keys used for entering retrieval information such as title, year, month, day, place of photographing, etc. when storing photographed images on the CD-ROM 4 every block.

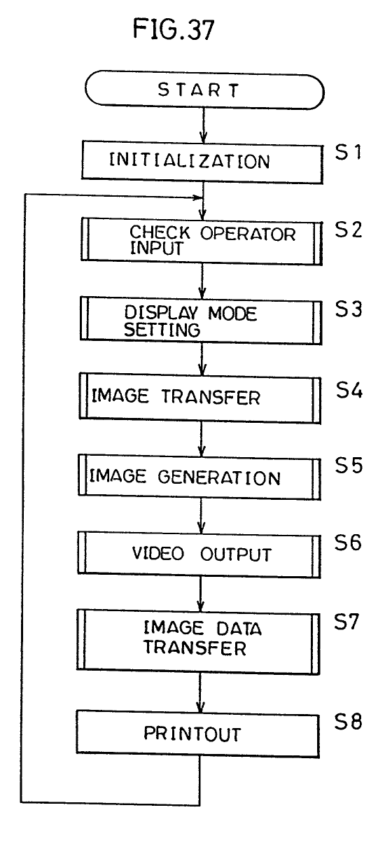

FIG. 37 is a flowchart showing operaton of the CD-ROM driver 3 for executing image editing operations such as retrieval or reproduction of images.

When the power switch 370 is turned on, the MPU 353, image memory 354, and associated units shown in FIG. 33 are initialized at first (S1). Next, checks are made to determine whether or not there is any operator input from the CD-ROM driver 3, remote controller 5 or the operating panel of the keyboard 6 (S2). After checking operator inputs, the display mode is selected to specify the image data to be monitored on the TV 7 (S3). Subsequently, the image data to be monitored is transferred to the image memory 354 (S4). Upon completion of image data transfer, the image processor 355 generates an image according to the display mode selected above (S5). The resultant image data is sent to the video interface 356 and displayed on the TV screen (S6). Further, the image data is transferred or printed (S7, S8) and the CD-ROM driver 3 returns to Step S2 to repeat the same sequence thereafter.

Operations performed in individual sub-routines are described further in the following.

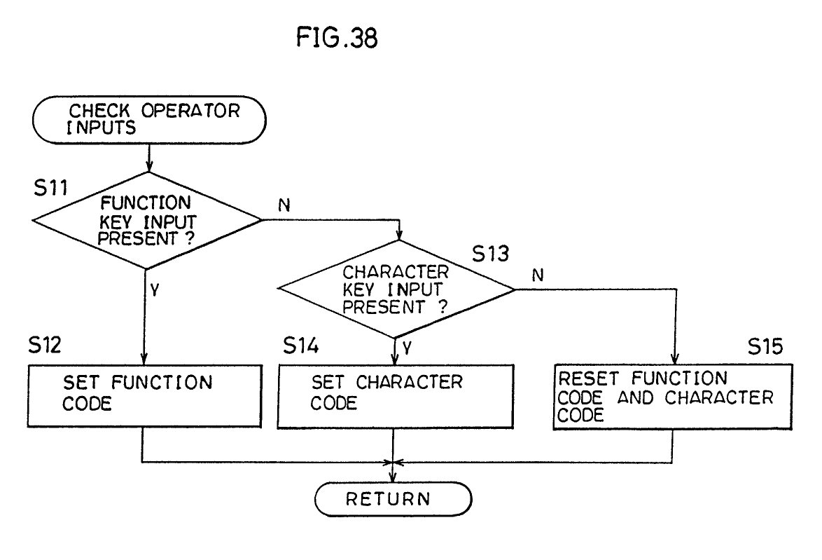

First, the operator input check procedure (S2 in FIG. 37) is explained referring to the flowchart shown in FIG. 38.

Checks are made by the CD-ROM driver 3, remote controller 5 or keyboard 6 to see that there is any input from the function key 371, 381 or 391 (S11). In case any input has been found (Yes in step S11), it is executed to set a function code to indicate the presence of an input from a function key (S12) and the routine returns to the main routine. On the contrary, should there be no input, the routine advances to step S13 to check for an input from the character keys of the keyboard 6. If there is any character key input (Yes in step S13), it is executed to set a character code to indicate the presence of an input from the character keys (S14) and the routine returns to the main routine. Should there be no input from either the function keys or character keys, the routine proceeds to Step S15 to reset the function code and character code and returns to the main routine.

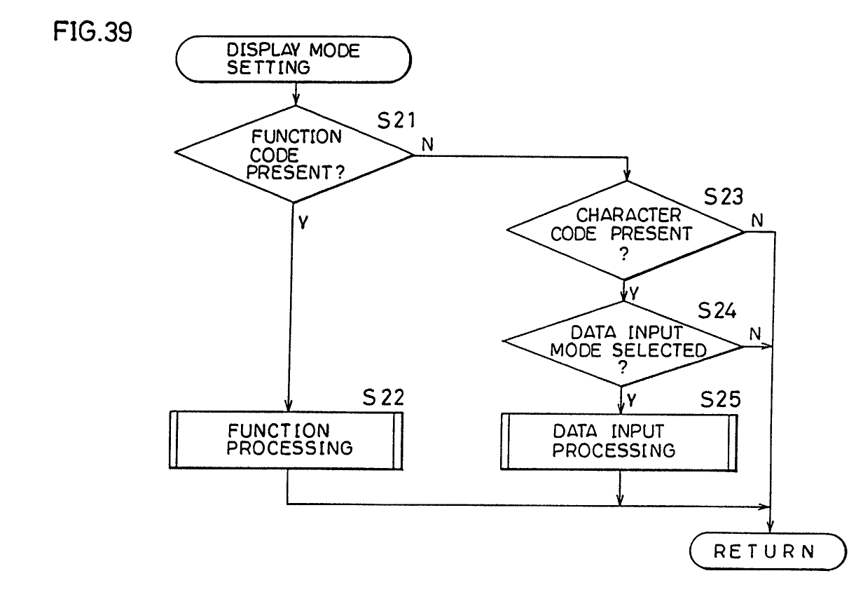

Next, the display mode setting procedure (S3 in FIG. 37) is explained in the following referring to the flowcharts shown in FIGS. 39 to 45.

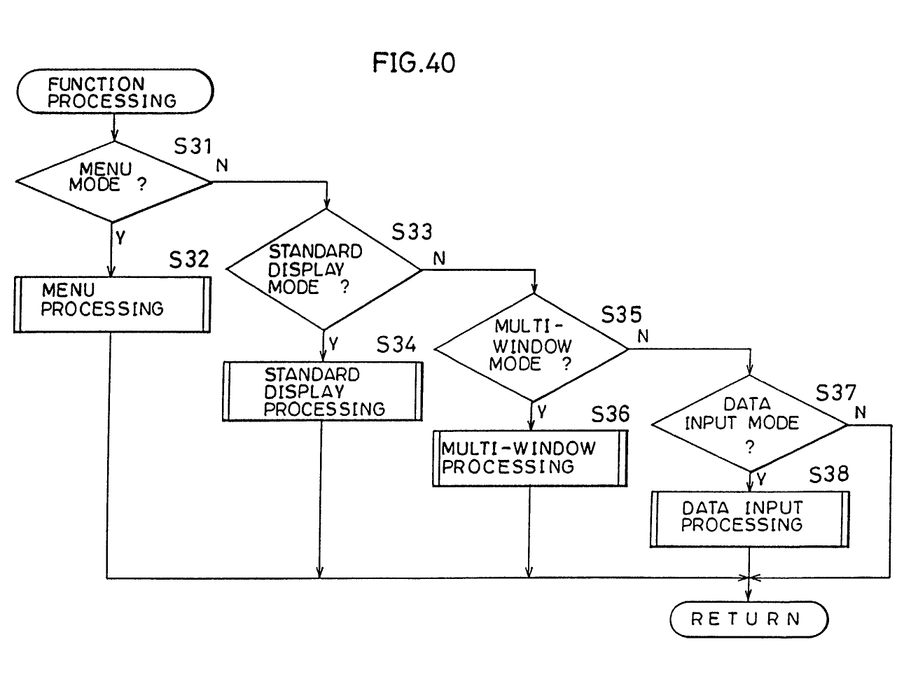

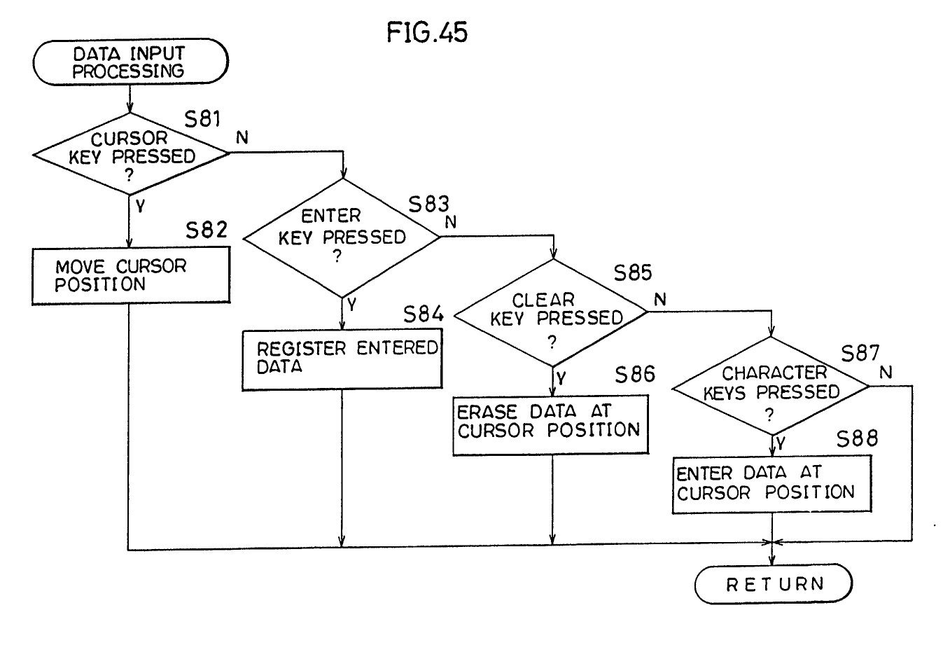

Referring to FIG. 39 at first, checks are made in Step S21 to see if a function code is set. If it is set (Yes in Step S21), the process advances to the function processing sub-routine shown in Step S22 (to be described later in FIG. 40). On the contrary, if is not set, checks are made in Step S23 to see that a character code is set. If a character code is set (Yes in Step S23) and the data input mode is currently selected (Yes in Step S24), the routine returns to the main routine after executing the data input processing sub-routine in Step S25 (to be described later in FIG. 45). On the other hand, if the data input mode is not selected even though a character code is set (No in Step S24), or if both codes are not set (No in both Steps S23 and S24), the routine simply returns to the main routine.

FIG. 40 is a flowchart of the above-mentioned function processing sub-routine in Step S22.

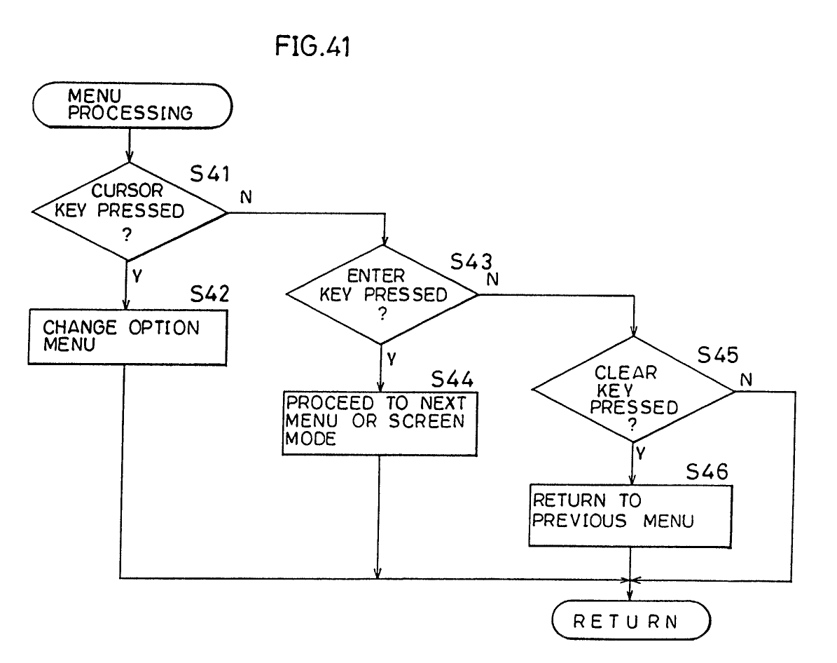

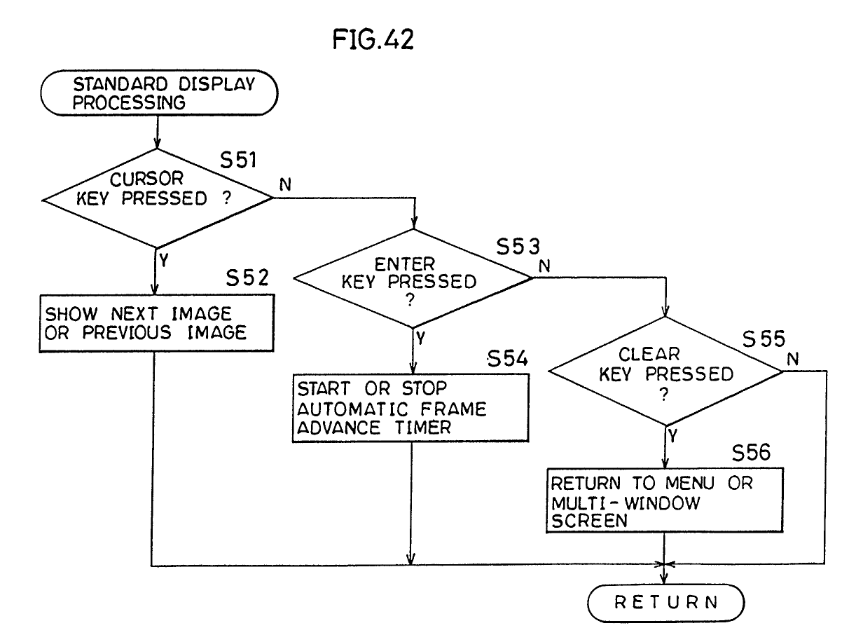

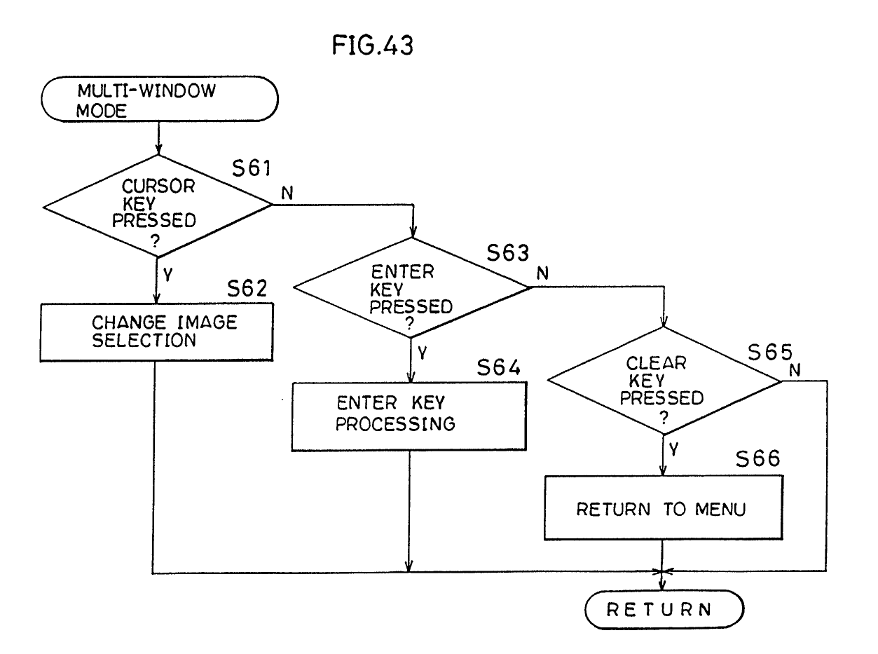

Checks are made in Step S31 to see that a menu mode screen is displayed on the TV 7. If the menu mode is selected (Yes in Step S31), the routine returns to the main routine after executing the menu processing sub-routine in Step S32 (to be described later in FIG. 41). If the menu mode is not selected, checks are made in Step S33 to see that the standard display mode is selected. The standard display mode refers to the mode in which the TV 7 displays a single image on its screen. If the standard display mode is selected (Yes in Step S33), the routine returns to the main routine after executing the standard display processing sub-routine in Step S34 (to be described later in FIG. 42). If the standard display mode is not selected, checks are made in Step S35 to see that the multi window mode is selected. The multi-window mode refers to the mode in which the screen of the TV 7 is slit into several windows to simultaneously display multiple images, 20 images in this preferred embodiment. If the multi-window mode is selected (Yes in Step S35), the routine proceeds to Step S36 to execute the multi-window processing sub-routine (to be described later in FIG. 43) and returns to the main routine. If the multi-window mode is not selected, checks are made in Step S37 to see that the data input mode is selected. If the data input mode is selected (Yes in Step S37), the routine returns to the main routine after executing the data input processing sub-routine in Step S38. If the data input mode is not selected, the routine directly returns to the main routine.

FIG. 41 is a flowchart of the above-mentioned menu processing sub-routine in Step S32.

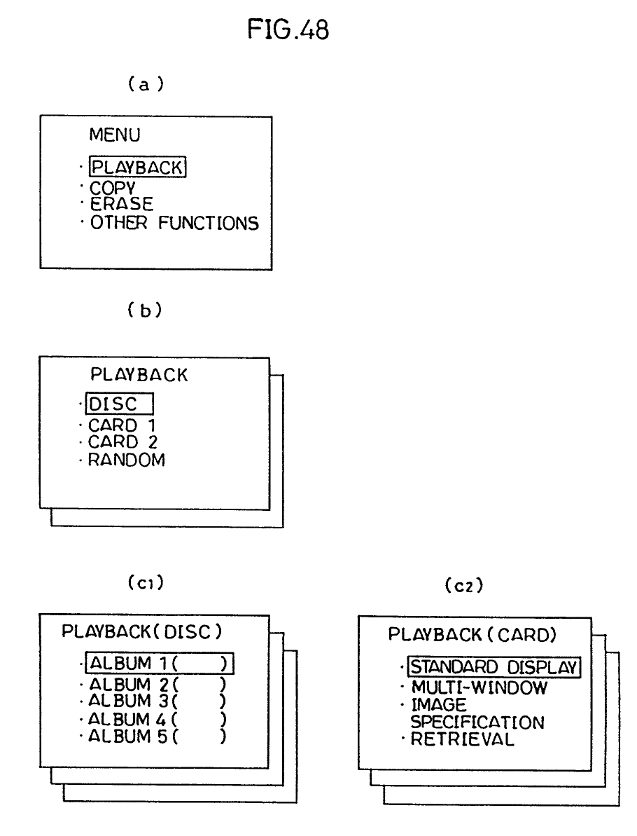

This sub-routine is explained in the following referring to menu pictures shown in FIGS. 48a-52.

First, FIGS. 48a-51b are explained. FIG. 48a is an initial menu picture displayed when the menu mode is selected. The currently selected item is highlighted in inversed video in this menu picture. When “Playback” is selected on the picture, images are reproduced on the TV 7. More specifically, when the enter key is turned on (or pressed) after selecting “Playback”, types of storage media in which images to be reproduced are recorded are displayed as shown in FIG. 48b. If the operator selects “Disc”, for example, on the picture of FIG. 48b, a list of “album numbers” corresponding to individual blocks on the disc (namely the CD-ROM 4) is displayed as shown in FIG. 48c1. If the operator further selects “Album 1” on the picture of FIG. 48c1, the TV monitor displays a menu of playback modes and associated options as shown in FIG. 48c2. Images recorded in Album 1 on the disc is finally reproduced when the operator presses the enter key again. On the other hand, if the operator selects “Card 1” on the picture of FIG. 48b, the TV monitor displays a menu picture of FIG. 48c2 for asking about the choice of reproduction modes and the need of retrieval for the images stored on Card 1. Pressing the return key when any of these sub-menus is displayed on the picture switches the on picture display back to the previous menu (or sub-menu). For example, the picture of FIG. 48c1 returns to the picture of FIG. 48b when the operator presses the return key. It then returns to the picture of FIG. 48a when the operator presses the return key again.

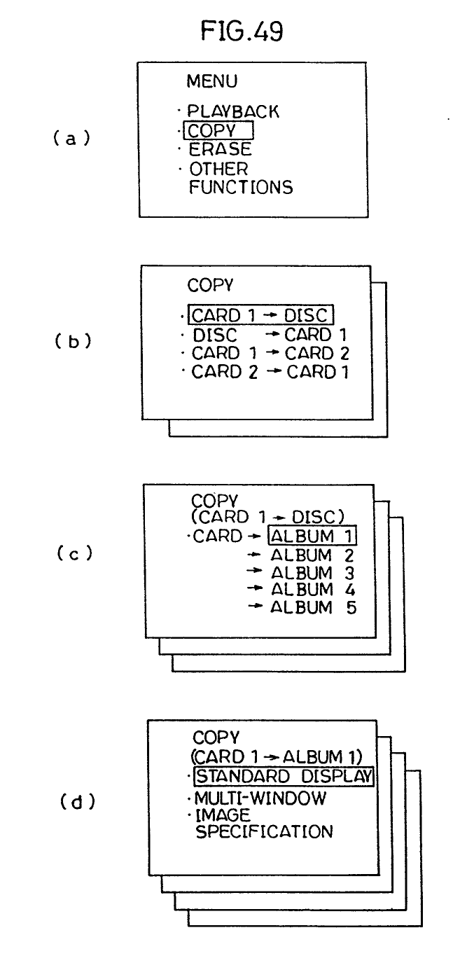

FIGS. 49a-49d show menu pictures displayed when “Copy” is selected in the menu mode. When “Copy” is selected on a picture of FIG. 49a, image transfer options are displayed a picture shown in FIG. 49b for allowing a choice of different source and destination storage medium combinations. If the operator selects “Card 1—Disc” on the picture of FIG. 49b, a list of “album numbers” is displayed a picture shown in FIG. 49c, indicating individual blocks in which images transferred from the IC card 2 will be recorded. Further, if the operator selects “Album 1” on the picture of FIG. 49c, options of image transfer types are displayed. If the operator presses the enter key when a picture shown in FIG. 49d is displayed, images stored on the IC card 2 is transferred in the form of standard display and recorded in the appropriate “album” on the disc. As already explained, each press of the return key sequentially switches the on-screen display back to the previous menu (or sub-menu).

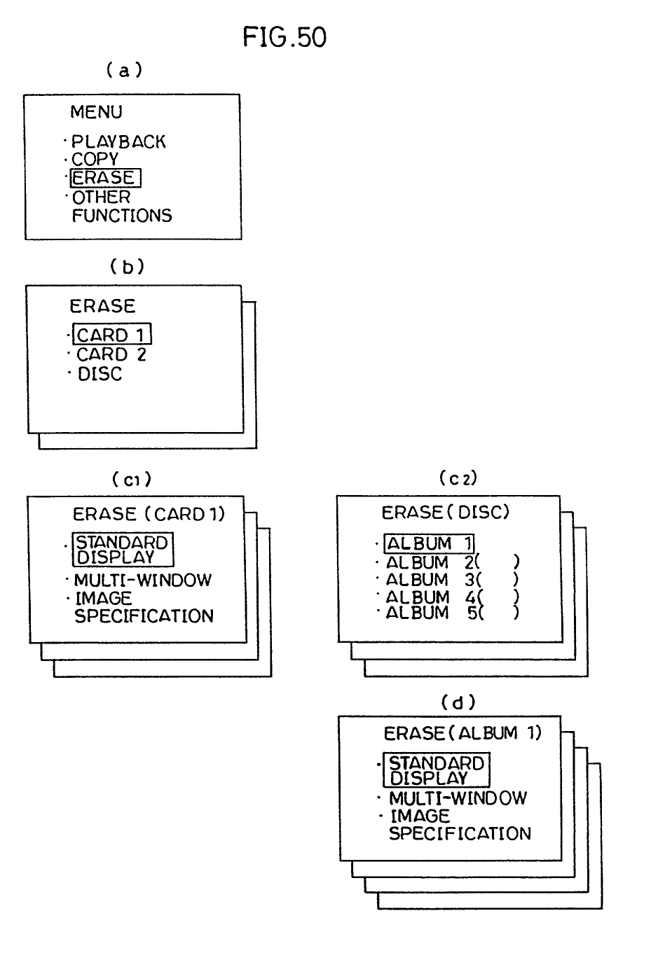

FIGS. 50a-50d show menu pictures displayed when “Erase” is selected in the menu mode. When “Erase” is selected on a picture shown in FIG. 50a, types of storage media from which recorded imaged can be erased are displayed as a picture shown in FIG. 50b. If the operator selects “Card” on the picture of FIG. 50b, a list of display modes from which recorded imaged can be erased is displayed as a picture shown in FIG. 50c1. On the other hand, if the operator selects “Disc” on the picture of FIG. 50b, a list of “album numbers” of which data contents can be erased from the disc is displayed as a picture shown in FIG. 50c2. If the operator selects “Album 1” on the picture of FIG. 50c2, then display modes of images to be erased are displayed. Further, if “Standard Display” or “multi-window” is selected on the picture of FIG. 50d, images stored in Album 1 is erased. On the other hand, if the operator selects “Image Specification”, an image specification picture (not illustrated) is displayed allowing him to specify each individual image. Consequently, the specified image is once reproduced on the screen so that the operator can verify the image before erasing it. As already explained, each press of the return key sequentially switches the on-screen display back to the previous menu (or sub-menu).

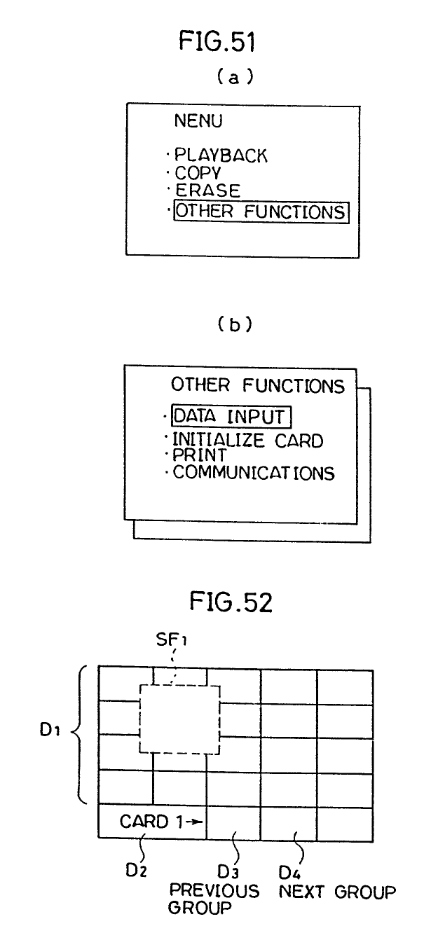

FIGS. 51a-51b show menu pictures displayed when “Other Functions” is selected in the menu mode. When “Other Function” is selected on a screen shown in FIG. 51a, a list of additional functions including “Data Input” to be described later is displayed as a picture shown in FIG. 51b. As already explained, each press of the return key sequentially switches the on-screen display back to the previous menu (or sub-menu).

In the sub-routine shown in FIG. 41, the on-screen presentation is controlled by checking the function keys of the CD-ROM driver 3, remote controller 5 and keyboard 6. More specifically, when a cursor key is pressed (or turned on) (Yes in Step S41), the option menu is changed in Step S42. As an example, if the cursor key is pressed when the picture of FIG. 48a is presented, the highlight moves to “Copy” enabling the copy function to be selectable. If the cursor key is pressed again, the highlight moves to “Erase”. In case the cursor key is not pressed, checks are made to see that the enter key is pressed in Step S43. When the enter key is pressed (Yes in Step S43), the routine advances to the next menu or changes from the menu mode to the screen mode in Step S44.

As an example, if the enter key is pressed when the picture of FIG. 48a is presented, the picture of FIG. 48b is displayed. If the enter key is pressed again, the picture of FIG. 48c1 is displayed in turn. On the other hand, if the enter key is pressed when the picture of FIG. 48c2 is displayed on the screen, the image data stored on the IC card 1 is presented on the TV 7 in the standard display mode. If the enter key is not pressed, in Step S45 it is checked whether the clear key is pressed. When the clear key has been pressed (Yes in Step S45), the routine returns to the previous menu in Step S46. As an example, if the clear key is pressed when the picture of FIG. 48cl is presented, the screen returns to the picture of FIG. 48b. If the clear key is pressed again, the screen returns to the picture of FIG. 48a.

FIG. 42 is a flowchart of the above-mentioned standard display processing sub-routine in Step S34.

In this sub-routine, the on-screen presentation is controlled by checking the function keys of the CD-ROM driver 3, remote controller 5 and keyboard 6 as well. More specifically, when the cursor key is pressed (or turned on) (Yes in Step S51), the currently reproduced image on the TV 7 is replaced by the next image or previous image in Step S52. In case the cursor key is not pressed, checks are made to see that the enter key is pressed in Step S53. If the enter key is pressed (Yes in Step S53), the timer for automatic frame advance of reproduced images is started or stopped to return to manual frame advance in which images are advanced by the cursor key. If the enter key is not pressed, in Step S55, it is checked whether the clear key is pressed. When the clear key has been pressed (Yes in Step S55), the screen returns to the menu mode picture or multi-window screen in Step S56. As an example, if the clear key is pressed when an image is reproduced on the TV 7, the screen returns to the picture of FIG. 48c2. Also, if the clear key is pressed when the multi-window screen has been switched to the standard display screen, the on-screen presentation reverts to the multi-window screen.

Now, the multi-window screen is explained in the following referring to FIG. 52.

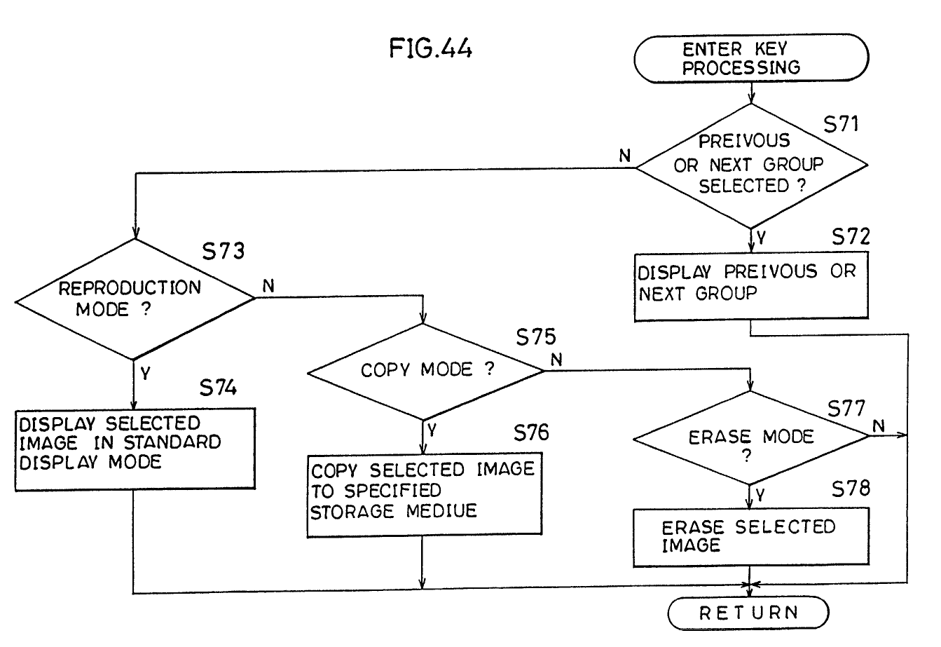

The multi-window screen is composed of display section D1 in which 20 frames of images are reproduced, for example, a display section D2 just below a display section D1 to show the type of storage medium which stores images to be reproduced, e.g. “Card 1→” as illustrated in FIG. 52, and display sections D3 and D4 to show “Previous Group” and “Next Group” respectively for allowing the operator to select the previous 20 frames or the next 20 frames of images. SF1 is a floating option menu window which can be moved across image frames in the display section D1 and the display sections D2 through D4 by operating the cursor keys. The sequences described below in FIGS. 43 and 44 are executed when the enter key is pressed.

FIG. 43 is a flowchart of the above-mentioned multi-window mode processing sub-routine in Step S36.

In this sub-routine, the on-screen presentation is controlled by checking the function keys of the CD-ROM driver 3, remote controller 5 and keyboard 6 as well. More specifically, when the cursor key is pressed (or turned on) (Yes in Step S61), the option menu window SF1 is moved vertically or horizontally across the multi-window screen showing the currently reproduced images on the TV 7 and the selected images or selection on the display sections D2 through D4 can be changed. In case the cursor key is not pressed, checks are made to see that the enter key is pressed in Step S63. If the enter key is pressed (Yes in Step S63), the enter key processing sub-routine (to be described later in FIG. 44) in multi-window mode is executed in Step S64. If the enter key is not pressed, in Step S65 it is checked whether the clear key is pressed. When the clear key has been pressed (Yes in Step S65), the routine returns to the menu mode in Step S66. As an example, if the clear key is pressed when multiple images are reproduced on the TV 7, the screen returns to the picture of FIG. 48c2.

FIG. 44 is a flowchart of the above-mentioned enter key processing sub-routine executed in the multi-window mode.

First in Step S71, checks are made to see that the display section D3 or D4 is selected in the option menu window SF1 shown in FIG. 52. If the display section D3 or D4 is selected (Yes in Step S71), 20 frames of images of the previous group or next group is reproduced in Step S72. If neither display section D3 nor D4 is selected checks are made to see that the multi-window reproduction mode is currently selected in Step S73. If the reproduction mode is selected (Yes in Step S73), the image selected in the option menu window SF1 is displayed in the standard display mode in Step S74. If the reproduction mode is not activated, checks are made to see that the copy mode is selected in Step S75. If the copy mode is selected (Yes in Step S75), the image selected in the option menu window SF1 is copied in Step S76 from the specified source medium to the specified destination medium, e.g. “Card—Disc”. If the copy mode is not selected, checks are made to see that the erase mode is selected in Step S77. If the erase mode is selected (Yes in Step S77), the image selected in Step S78 is erased.

FIG. 45 is a flowchart of the above-mentioned data input processing sub-routine in Step S38.

In this sub-routine, the on-screen presentation is controlled by checking the function keys of the CD-ROM driver 3, remote controller 5 and keyboard 6 and the character keys 392 of the keyboard 6. More specifically, the on-screen cursor position changes when a cursor key is pressed (or turned on) (Yes in Step S81), and retrieval data entered in Step S84 is registered when the enter key is pressed (Yes in Step 583). On the other hand, when the clear key is pressed (Yes in Step S85), retrieval data at the cursor position is erased in Step S86. Next, retrieval data is entered at the cursor position in Step S88 when character keys are pressed (Yes in Step S87). The retrieval data comprises place, year, month and day of photographing and additional information to be used as a search index attached to each individual “album” or block of images. These data are entered via the character keys 392 when the images are recorded on the CD-ROM 4, and can be reentered after erasing.

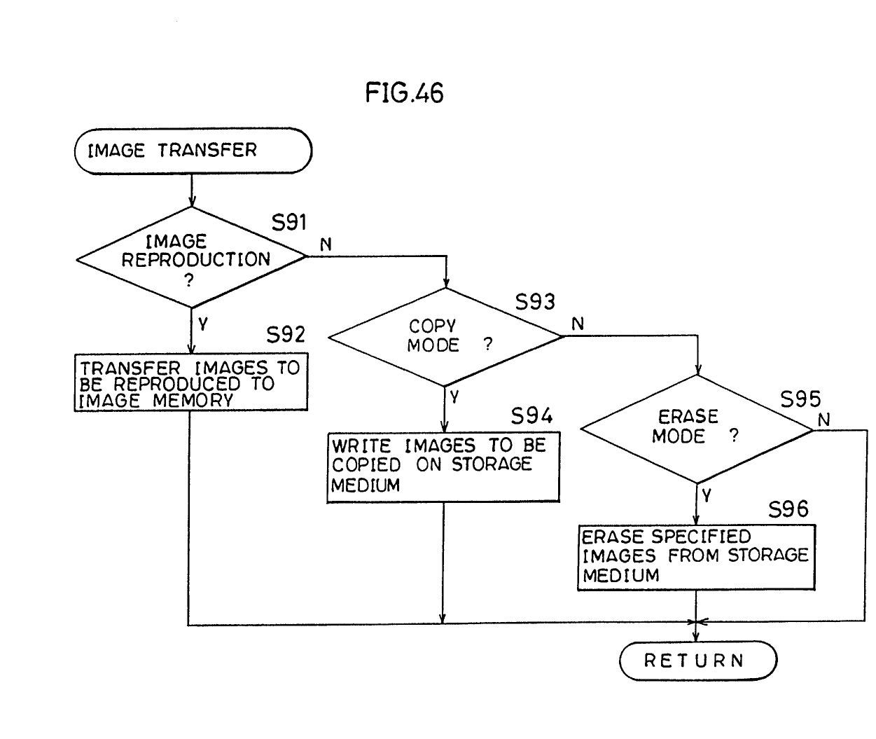

FIG. 46 is a flowchart of the above-mentioned image transfer sub-routine in Step S4.

The image transfer sub-routine is executed when a display mode has been set in the sub-routines shown above in FIGS. 39 through 46. More specifically, when the reproduction mode is selected in Step S91 (Yes in Step S9l), images to be reproduced are transferred to the image memory 354 in Step S92 to prepare for image reproduction. When the copy mode is selected (Yes in Step 93), images to be copied are written on an appropriate storage medium in Step S94. When the erase mode is selected (Yes in Step 93), the specified images are erased from an appropriate storage medium in Step S96. Upon completion of image transfer, image generation is executed.

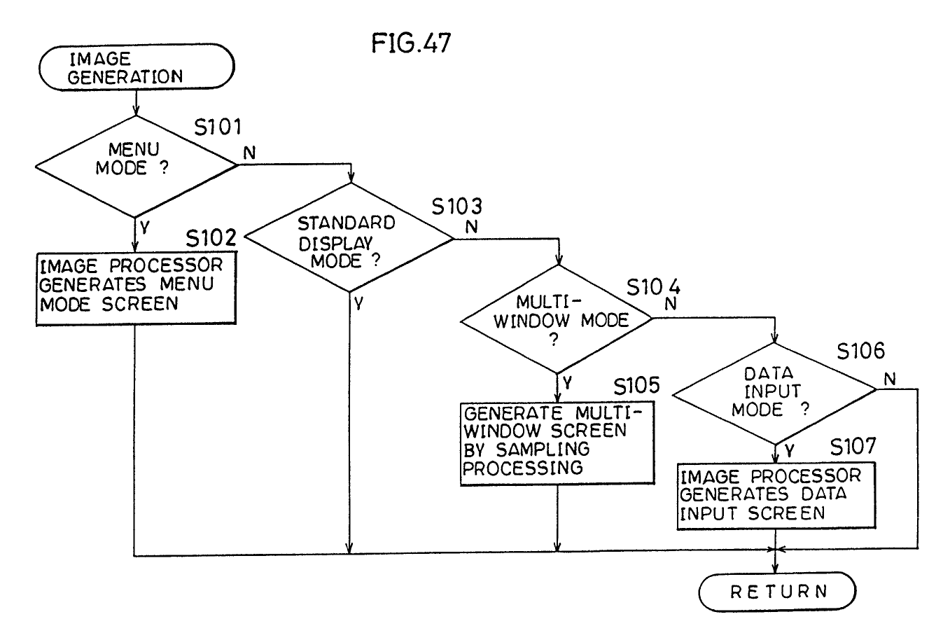

FIG. 47 is a flowchart of the above-mentioned image generation sub-routine in Step S5.

First, checks are made to see if the menu mode picture is displayed or not. When the menu mode picture is to be displayed (Yes in Step S101), the image processor 355 generates the menu mode picture in Step S102. On the other hand, when reproducing an image in the standard display mode (Yes in Step S103), the image in the image memory 354 is directly reproduced. Also, when reproducing images in the multi-window mode (Yes in Step S104), the image processor 355 performs appropriate data sampling to the images stored in the image memory 354 and then generates the multi-window screen in Step S105. In case the data input mode is selected (Yes in Step S106), the image processor 355 generates the data input screen in Step S107. Upon completing the above processes, the routine returns to the main routine shown in FIG. 37.

The image data generated in Steps S2 through S5 in FIG. 37 is output to the video interface 256 in Step S6, and reproduced or displayed on the TV 7. Further, the operations of S7 and S8 are executed and the routine returns to Step S2. The above sequence is repeated thereafter.

A separate keyboard is used as input means for retrieval information in this preferred embodiment of the invention. Instead, the keyboard may integrally constitute the CD-ROM driver 3.

The reproduction of images by means of a TV, videophone, CD-ROM and facsimile machine has been described. When a handy copier 12 shown in FIG. 1 is used to reproduce an image, its reader section (including a light source, a lens, an image sensor, etc.) substitutes for the IC card 2. In other words, the image stored on the IC card 2 is printed. The printout manner (including signal processing) is the same as explained in FIG. 5.

Digital memories are used as storage media in this preferred embodiment of the invention. These can be replaced by analog memories. For example, a floppy disc may be used instead of the IC card and an optical disc for analog recording may be used instead of the CD-ROM. Moreover, the CD-ROM may be replaced by an magneto-optical disc or a DAT suitable for recording of the PCM signal.

The present preferred embodiment of the invention employs the heat transfer printing method. Alternatively, it is possible to use a thermal printer, sublimation type printer or melt-out type printer. Also, a black and white printer may be used instead of the color printer.

Furthermore, the camera unit 1 may be provided with an internal printer with its printing paper and paper feed mechanism housed all together in a single cabinet or an external printer.

Although the present invention has been fully described by way of example with reference to the accompanying drawings, it is to be understood that various changes and modifications will be apparent to those skilled in the art. Therefore, unless otherwise such changes and modifications depart from the scope of the invention, they should be construed as being included therein.

What is claimed is:

1. An image information processing system comprising:
a storage medium having a plurality of recordable portions;
selection means for selecting one of the plurality of recordable portions; and
recording means for recording image information on the selected recordable portion.

2. An image information processing system according to claim 1 further comprising input means for inputting rewritable retrieval image information for each of the plurality of recordable portions.

3. An image information processing system according to claim 2 further comprising reproduction means for reproducing an image in accordance with the image information recorded on the recordable portion designated by one of the selection means and the input means.

4. An image information processing system according to claim 1 wherein the storage medium is a CD-ROM.

5. An image information processing system according to claim 2 wherein the rewritable retrieval image information includes the photographing place, photographing date, photographer's name, and contents of the image.

6. An image information processing system comprising:
a first storage medium for recording image information;
a second storage medium having a plurality of recordable portions;
transfer means for transferring the image information recorded on the first storage medium to the second storage medium;
designation means for designating a recordable portion of the second storage medium for the image information to be transferred; and
recording means for recording the image information on the designated recordable portion.

7. An image information processing system according to claim 6 further comprising input means for inputting rewritable retrieval image information for each of the plurality of recordable portions of the second storage medium.

8. An image information processing system according to claim 7 further comprising reproduction means for reproducing an image in accordance with the image information recorded on the recordable portion designated by one of the designation means and the input means.

9. An image information processing system according to claim 6 wherein the first storage medium is an IC card.

10. An image information processing system according to claim 6 wherein the second storage medium is a CD-ROM.

11. An image information processing system according to claim 7 wherein the rewritable retrieval image information includes the photographing place, photographing date, photographer's name, and contents of the image.

12. A system for recording a photographed image comprising:
a camera including;
a first reception unit for receiving a memory card;
image signal generation means for generating an analog image signal:
first signal processing means for converting the analog image signal to a digital image signal, and compressing the digital image signal;
first recording means for recording the compressed image signal on the memroy card; and
an editing device including;
a second reception unit for receiving a memory card and an optical disc;
second signal processing means for expanding the compressed image signal recorded on the memory card;
designation means for designating a recordable portion of the optical disc for the expanded image signal; and
second recording means for recording the expanded image signal on the designated recordable portion.

13. A system for recording a photographed image according to claim 12 wherein the first signal processing means compresses the digital image signal in the DCT manner.

14. A system for recording a photographed image according to claim 12 wherein the optical disc is a CD-ROM.

15. An editing device comprising:
a reception unit for receiving a plurality of storage mediums, each storage medium being capable of recording and reading image information;
selection means for selecting a pair of a storage medium having image information to be transferred and another storage medium for recording the image information among the plurality of storage mediums;
transfer means for transferring the image information between the selected pair of storage mediums.

16. An editing device according to claim 15 wherein the plurality of storage mediums including storage mediums having differnt storage capacities, the selection means provides a selection of a pair of storage mediums having different capacities.

17. An editing device according to claim 16 wherein the storage medium is a CD-ROM.

18. An editing device according to claim 17 wherein the storage medium is an IC card.

19. An editing device according to claim 15 wherein the selection means provides a selection of a pair of IC cards.

20. A camera comprising:
a camera body;
storage means including a first memory capable of storing image information corresponding to two photographic frames or more, and a second memory;
recording means for recording image information on one of the first memory and the second memory;
changer means for changing from the recording of image information on the first memory to the recording of image information on the second memory and vice versa.

21. A camera according to claim 20 wherein the first memory is detachably mountable to the camera body, and the second memory is fixedly provided in the camera body.

22. A camera according to claim 20 wherein the first memory is an IC card.

23. A camera comprising:
a camera body;
storage means including a first memory capable of storing image information corresponding to two photographic frames or more, and a second memory;
reproduction means for reproducing image information recorded on one of the first memory and the second memory;
changer means for changing from the reproduction of image information recorded on the first memory to the reproduction of image information recorded on the second memory and vice versa.

24. A camera according to claim 23 wherein the first memory is detachably mountable to the camera body, and the second memory is fixedly provided in the camera body.

25. A camera according to claim 23 wherein the first memory is an IC card.

26. An editing device comprising:
a first reception unit for receiving a first storage medium holding image information;
a second reception unit for receiving a second storage medium having a plurality of recordable portions;
transfer means for transferring image information recorded on the first storage medium to the second storage medium;
designation means for designating a recordable portion of the second storage medium for the image information to be transferred; and
recording means for recording the image information on the designated recordable portion.

27. An editing device according to claim 26 further comprising input means for inputting rewritable retrieval image information for each of the plurality of recordable portions of the second storage medium.

28. An editing device according to claim 26 wherein the first reception unit is adopted for receiving an IC card.

29. An editing device according to claim 26 wherein the second reception unit is adopted for receiving a CD-ROM.

30. An editing device according to claim 26 wherein the rewritable retrieval image information includes the photographing place, photographing date, photographer's name, and contents of the image.

31. An editing device for a camera capable of compressing an image signal and recording the compressed image signal on a memory card comprising;
a first reception unit for receiving a memory card;
a second reception unit for receiving an optical disc;
signal processing means for expanding the compressed image signal recorded on the memory card; and
recording means for recording the expanded image signal on the optical disc.

32. An editing device according to claim 31 wherein the signal processing means expands the compressed image signal in the DCT manner.
